(19) United States
(12) Patent Application Publication
(10) Pub. No.: US 2008/0010351 A1
(43) Pub. Date: Jan. 10, 2008

(54) SURVEY POLLING SYSTEM AND METHOD

(75) Inventors: Tyler G. Wardhaugh, San Diego, CA (US); Christopher J. McGreal, San Diego, CA (US)

Correspondence Address: NORTH OAKS PATENT AGENCY, 45 ISLAND ROAD, NORTH OAKS, MN, 55127, US

(73) Assignee: Digital River, Inc., Eden Prairie, MN (US)

(21) Appl. No.: 11/669,787

(22) Filed: Jan. 31, 2007

Related U.S. Application Data
(60) Provisional application No. 60/764,091, filed on Jan. 31, 2006.

(51) Int. Cl. G06F 15/16

(52) U.S. Cl. 709/206

(57) ABSTRACT

In accordance with one embodiment of the invention, a computerized survey polling system wrapper for use on the internet or other network is described. Survey polling system and method allows an administrator to set up a survey and manipulate and segment responders based on simple answers to certain questions. The survey polling system utilizes heuristics to automatically categorize responders based upon their responses. For example, responders may get three points for answering question one with “A”, two points for “B”, ten points for “C”. For question two, responders may get zero points for “A”, one point for “B”, and five points for “C”. Thereafter, the survey polling system will place the responders in categories based on the final point totals. In this manner, an administrator may create a survey and send the survey to a subscriber list or base with the intent of getting the population into relevant groupings.

### RELATED APPLICATIONS

This application claims the benefit of U.S. Provisional Application No. 60/764,091 filed 31 Jan. 2006, entitled “Survey Polling,” which is incorporated herein by reference.

### FIELD OF THE INVENTION

The present invention relates to electronic survey systems for use on the internet. More particularly, the present invention relates to a system and related tools for survey polling.

### BACKGROUND OF THE INVENTION

“Everyone takes surveys. Whoever makes a statement about human behavior has engaged in a survey of some sort.” These words by the American clergyman Andrew Greeley are an example of how widespread the use of surveys is ingrained in the human experience. The American Psychological Association defines surveys as taking a general or comprehensive view of or appraisal of an area of study or situation. Furthermore, they define survey as to view in detail, especially to inspect, examine, or appraise formally or officially in order to ascertain condition and value. Due to the dramatic increase of the number of Internet users by the widespread use of personal computers, surveys asking for replies in e-mail have become popular as an alternative to surveys by paper and telephone. The surveys by paper and telephone suffer from the possibility of paper damage or loss.

Additionally, electronic commerce (e-commerce) companies often utilize surveys to gather information for their subscriber lists and email campaigns. E-commerce companies use targeted e-mail to communicate and sell to their customers. Targeted e-mail seems to be one of healthiest direct-marketing ways to build brand equity.

Accordingly, the ability to market a product or service to individuals who are accessible on the Internet is becoming increasingly important. Email systems exist today for sending email to a target set of email addresses for purposes such as marketing, information acquisition, and otherwise. A system for sending email to a number of email targets for such purposes may be called an email campaign.

Present email campaigns may suffer from difficulties in locating a pool of relevant individuals to be contacted. In a small email campaign, each email sent is critical to the success of the campaign, and needs to be carefully created. In other situations, large numbers of individuals to be contacted may have been found. This may result in increased difficulty in tailoring the large number of required email messages to the individuals for more effective contact.

Furthermore, once an email campaign has been initiated, difficulties in measuring success of the email campaign are presented. Effective ways for determining whether email recipients have received email from the email campaign have been sought. Also, effective ways for allowing the email recipients to provide feedback have also been sought. It is desirable for the email recipients to be able to respond with feedback, and for the quantity and content of the responses to be monitored and tracked. Furthermore, conducting advanced database search queries, then saving and managing these searches automatically is desirable as well.

Respecting subscribers to an email is also important. A message that's too focused risks missing out on impulse or crossover buys. According to a recent survey by Return Path, the number of consumers who are reporting opt-in email as spam to their Internet Service Provider (ISP) is up from 23.4% at the end of 2004 to nearly 34% at the end of 2005. The top reasons cited for the increase are lack of content relevancy and ratcheting up frequency beyond subscriber expectations. Moreover, according to a new Hostway survey, 70% of consumers said they would not purchase from websites that committed these pet peeves: pop-up advertising, registration log-on pages, software installation, and slow-loading pages. In addition, there is powerful evidence citing how effective email is when driving traffic to an online sale. In a recent Email Insider report, retailers who used email to promote post-holiday sales saw traffic increases of up to 700% above pre-holiday numbers.

Email deliverability will continue to be a major issue, and there are several deliverability challenges. Some like authentication methods and challenge-response functionality will be addressable by meeting technological specifications. But the most important factors affecting deliverability will continue to be reputation and respectful sending practices.

Furthermore, e-marketers' use of segmentation strategies and testing will become increasingly sophisticated. Marketers are getting smarter and the technology is too. Upcoming advances in email functionality like easier-to-use dynamic content, more robust testing capabilities, and deeper integration with web analytics providers will give businesses even more actionable information to drive sales and build relationships.

Additionally, there is a right and wrong way to build a list. A list is basically a database of subscribers. If a business wants to build an email marketing program, the best thing is not to purchase or borrow a list. Otherwise, they will be reported as a spammer. The best, most effective way to obtain a good list is to build it from the ground up. Building a database does not have to be difficult. In fact, it is one of the best ways to streamline marketing strategy to deliver measurable returns. In growing quality permission—based list, the website is the best and most obvious place to build a list. If someone is surfing on the website, the business has a stellar opportunity to transform a web user from an interested party to a loyal patron. Usually there will be some link on the website that asks users to “Register Now” or “Subscribe Today” for a free e-newsletter, for more information, or for exclusive sales, offers and promotions. A survey page that is easy to fill out (name and email address are most important) is the next step. This information can then be used in a database.

Great lists, like great buildings, are not built overnight. It takes time, often a few years, to grow a list that delivers big returns. A slowly built list ensures that users grow a community of patrons who rarely opt out. Email marketing campaigns are best implemented when integrated with and supported by other marketing efforts. That means the email marketing strategy should be part of printed collateral, in store and on-location promotions, advertising and trade show booth promotions. Every piece of paper about the business should include a link to the website and email subscription information.

A solution to make segmentation easier and more efficient for web analytic e-commerce companies is to utilize surveys to gather customer data. The data for subscriber lists segmentation based on customer profile information such as shopping behavior and interests can be gathered through polls. The present invention makes subscriber list segmentation easier and more efficient by utilizing polls.

The present invention provides a solution to these needs and other problems, and offers other advantages over the prior art.

### BRIEF SUMMARY OF THE INVENTION

The present invention is related to a software system that solves the above-mentioned problems. In accordance with one embodiment of the invention, a computerized survey polling system wrapper for use on the internet or other network is described. Survey polling system and method allows an administrator to set up a survey and manipulate and segment responders based on simple answers to certain questions. The survey polling system utilizes heuristics to automatically categorize responders based upon their responses. For example, responders may get three points for answering question one with “A”, two points for “B”, ten points for “C”. For question two, responders may get zero points for “A”, one point for “B”, and five points for “C”. Thereafter, the survey polling system will place the responders in categories based on the final point totals. In this manner, an administrator may create a survey and send the survey to a subscriber list or base with the intent of getting the population into relevant groupings.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates a diagram outlining the components of building a survey.

FIG. 2 shows a root folder view for a survey library.

FIG. 3 shows design features of a survey library.

FIG. 4 shows a child folder of a sub folder.

FIG. 5 shows a survey details view.

FIG. 6 shows details of naming a folder.

FIG. 7 illustrate actions to be taken on a survey

FIG. 8 illustrates a modal dialogue window to choose a skin.

FIG. 9 shows a page to enter a new name for a survey or folder.

FIG. 10 illustrates a page to make a re-named copy of a survey or folder while leaving the original unchanged.

FIG. 11 illustrates a move survey or folder window.

FIG. 12 illustrates a delete survey or folder window.

FIG. 13 illustrates a launch detail window.

FIG. 14 illustrates a window to change online settings.

FIG. 15 illustrates an offline settings tab to take surveys offline.

FIG. 16 illustrates a survey uniform resource locator panel.

FIG. 17 illustrates details of an access tab.

FIG. 18 illustrates an edit survey page.

FIG. 19 illustrates further details of an edit survey page for building multiple surveys.

FIG. 20 illustrates a page to insert a question or custom HTML.

FIG. 21 shows a window for insert buttons.

FIG. 22 shows a question panel.

FIG. 23 shows an expanded view of a question panel.

FIG. 24 shows a window to move a question to a different branch, page, or specific location.

FIG. 25 shows a remove prompt.

FIG. 26 shows a page for an insert button.

FIG. 27 shows a template for choosing question types.

FIG. 28 shows a page for inserting a new question.

FIG. 29 shows a page to insert a new question regarding drop down states.

FIG. 30 further shows a page to insert a new question regarding drop down states.

FIG. 31 shows a page to insert questions regarding check boxes.

FIG. 32 illustrates a page to insert questions regarding radio buttons.

FIG. 33 illustrates a page to insert questions regarding phone numbers.

FIG. 34 illustrates a page to insert questions regarding email addresses.

FIG. 35 illustrates a page to insert questions regarding open text.

FIG. 36 illustrates a page to insert questions regarding matrices.

FIG. 37 illustrates a page to insert an existing question.

FIG. 38 illustrates a page to insert custom HTML into a survey.

FIG. 39 illustrates page to insert conditional logic questions.

FIG. 40 illustrates a branches tab.

FIG. 41 illustrates an introduction page tab.

FIG. 42 illustrates an exit page tab.

FIG. 43 illustrates a group fill tab.

FIG. 44 illustrates a filters page.

FIG. 45 shows a library for survey skins and templates.

FIG. 46 shows an expanded skin library.

FIG. 47 shows a standard skin creation panel.

FIG. 48 shows a page to create a custom survey footer.

FIG. 49 shows a formatting tab in a standard skin creation panel.

FIG. 50 shows a buttons style tab in a standard skin creation panel.

FIG. 51 illustrates page properties of a standard skin creation panel.

FIG. 52 illustrates a custom skin creation panel.

FIG. 53 illustrates a custom skin creation panel with a formatting tab.

FIG. 54 illustrates a custom skin creation panel with a buttons tab.

FIG. 55 illustrates a summary data response display page.

FIG. 56 displays a range of answers to a particular question type.

FIG. 57 illustrates a filter applied to an entire survey statistical report or to individual questions.

FIG. 58 illustrates a tutorial index.

### DETAILED DESCRIPTION

In accordance with one embodiment of the invention, a computerized survey polling system and method 101 for use on the internet or other network 103 is described. Survey polling system and method 101 allows an administrator 100 to set up a survey and manipulate and segment responders based on simple answers to certain questions. The survey polling system 101 utilizes heuristics to automatically categorize responders based upon their responses. For example, responders may get three points for answering question one with “A”, two points for “B”, ten points for “C”. For question two, responders may get zero points for “A”, one point for “B”, and five points for “C”. Thereafter, the survey polling system 101 will place the responders in categories based on the final point totals. In this manner, an administrator 100 may create a survey and send the survey to a subscriber list or base with the intent of getting the population into relevant groupings.

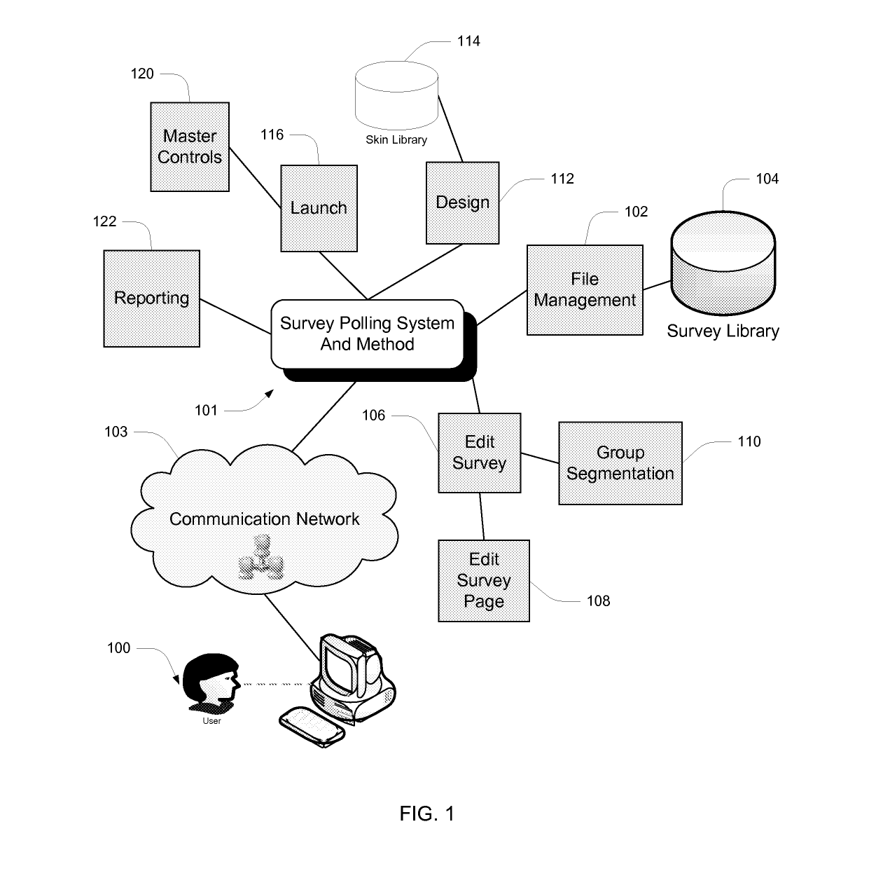

FIG. 1 illustrates a diagram outlining the components of building a survey. The survey administrator 100 is primarily concerned with five main operations when building a survey: file management, edit survey, design, launch and reporting. File management 102 includes a process of creating, storing and organizing surveys and survey skins (templates) via a survey library 104. Edit survey 106 is a process of defining questions and answers, page construction, branch construction and any logic that may be assigned to quality assurance via an edit survey page 108. Group segmentation 110 based on response data is also managed from this panel. It will be understood by one of ordinary skill in the art that response data may utilize subscriber email lists to gather information on customer demographics and shopping behavior.

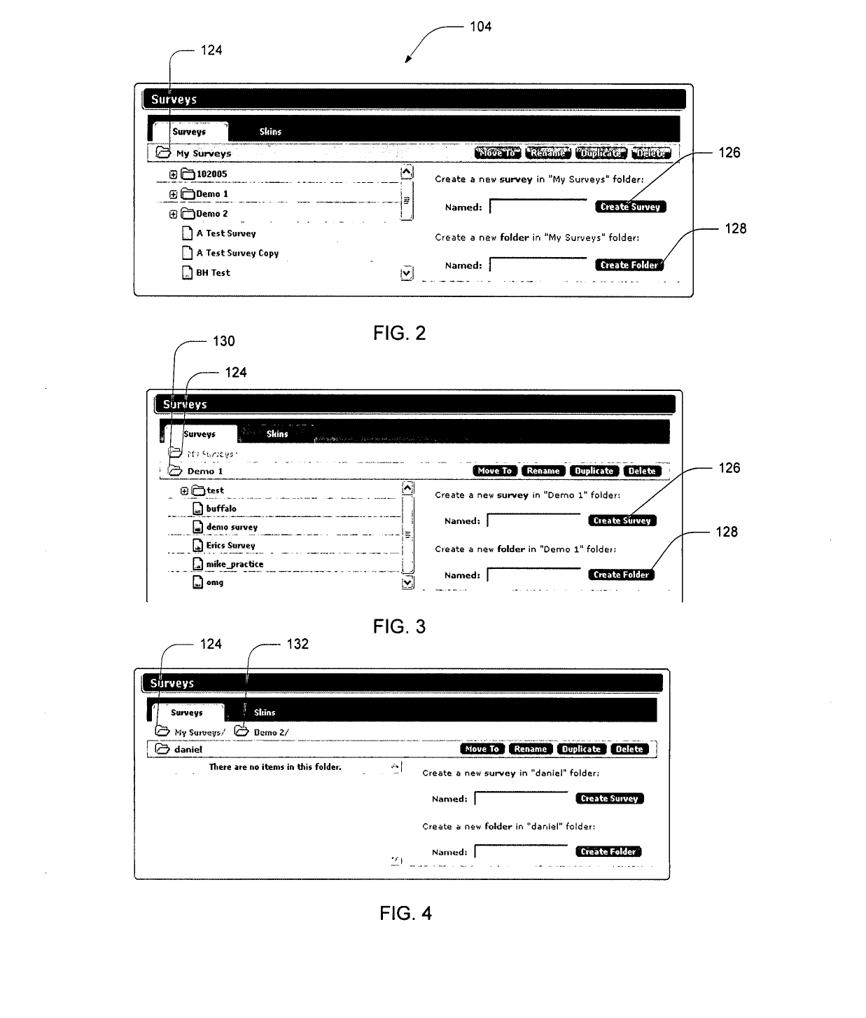

Turning again to FIG. 1, design 112 refers to the process of creating a “skin” or look and feel for a survey page. Skins are saved and managed in a skins library 114. In a preferred embodiment of survey polling system and method 101, skins exist independently of the surveys themselves and may be applied to several surveys at once. It is also possible to change the look and feel of a survey by simply toggling between any previously defined skins in a survey template library. Launch 116 details include a defining of access permissions for survey respondents, a start date, an end date and/or a total survey respondent limit for the survey. There are also master controls 120 to turn a survey off or on. This also defines a static uniform resource locator (URL) of the survey and will generate a dynamic subscriber email invitation link to the survey. Lastly, reporting 122 refers to viewing or exporting any or all statistical data available from a survey result. In a preferred embodiment, survey library 104 displays a contents list of files (surveys) and or folders that live in the current folder shown in the header. This is explained further in FIGS. 2-4.

Referring now to FIG. 2, a root folder view 124 for the survey library 104 is shown. In the survey polling system and method 101, the survey library 104 is a file management system. This allows the administrator 100 to name, manage, and store active and inactive surveys in a folder system. The use of folders is optional to the administrator 100. There are no “rules” as to how to store files in the library 104. It is up to the discretion of the administrator 100. The administrator 100 may create 126, store 128, and organize surveys here.

As shown in FIG. 3, some of the design features of the library 104 are shown. At the top of the survey library 104 is a breadcrumb navigation that displays an opened sub folder 130. The folder icon is open and to the left of the name. The root folder 124, for example, is called “My Surveys”. It will be understood by those skilled in the art that the location of icons and breadcrumb navigation on survey polling system and method 101 may vary.

In a preferred embodiment of survey polling system and method 101, when the administrator 100 opens a child folder the parent folder becomes “grayed-out” and the open child folder is displayed in a header bar above a scrollable window. It will be evident to one of ordinary skill in the art that breadcrumb navigation is a textual representation of where and how information is located within a website. It displays how major categories of information are linked along a continuum of sequential order. The breadcrumbs are active links back to the folder. There is no limit to the number of tiers or generations of folders. Again as in FIG. 2, the actions of creating 126, storing 128, and organizing surveys may be done. FIG. 4 shows a child folder 132 (shown as “Demo 2”) of the sub folder 130.

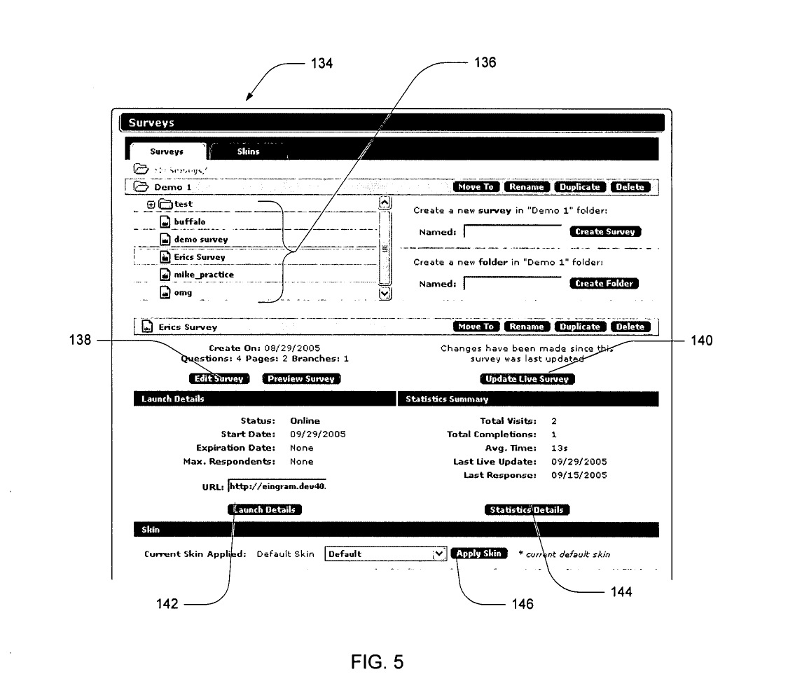

FIG. 5 shows survey details view 134. Clicking on a name of a survey in a contents list 136 expands the library 104 to expose a dashboard of information about the survey and access to different control pages for the survey including edit survey 138, update 140 (if edits have been made to the survey), launch summary 142 (details button), stats summary 144 (details button), and skin setting 146.

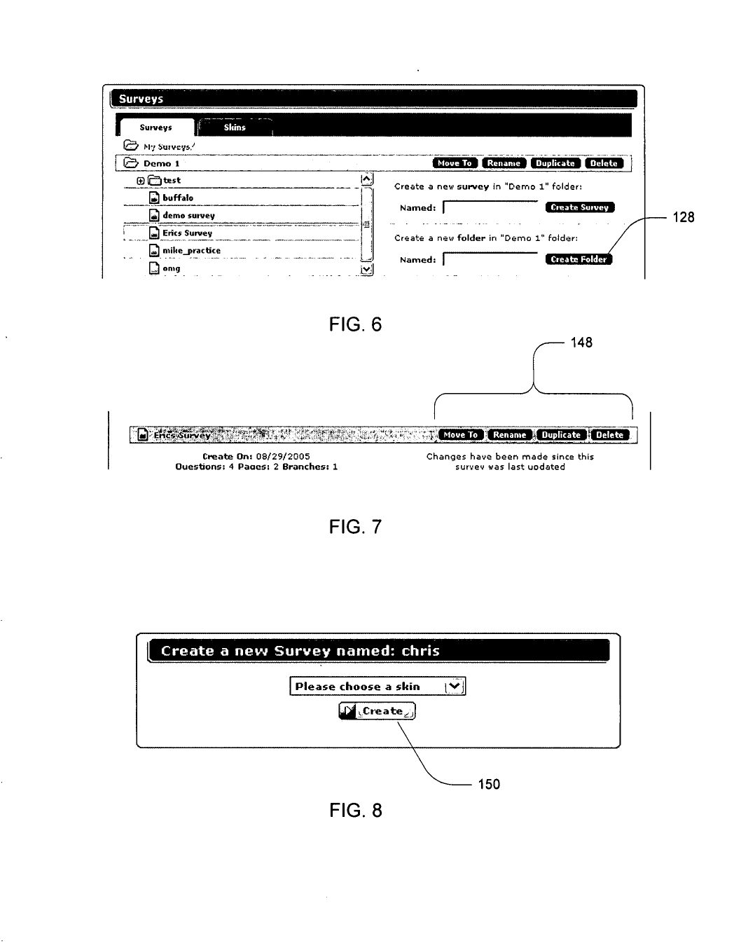

In another embodiment of survey polling system and method 101, as shown in FIG. 6, the administrator 100 may enter a name for a new folder into a text field and click on a “Create folder” 128 button to generate a folder in the file list. The page will refresh on submission with the folder added to the file list. Furthermore, more actions can be to taken on a survey. As shown in FIG. 7, these actions include “Move To”, “Rename”, “Duplicate”, and “Delete” (collectively 148).

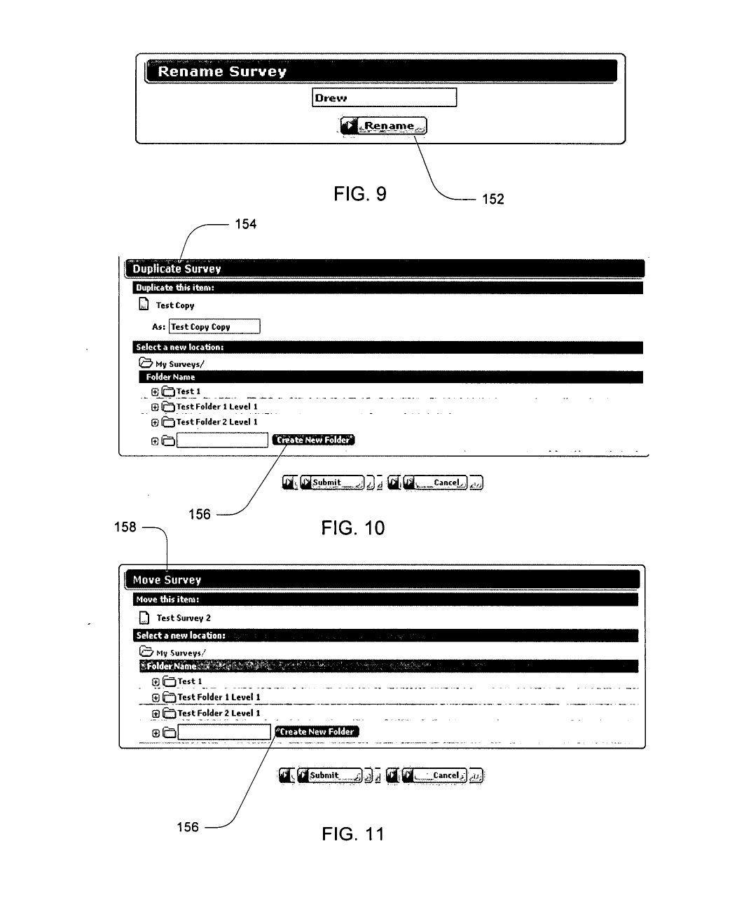

In FIG. 8, clicking the “Create new survey” 124 button will open a modal dialogue window that allows the administrator 100 to pick a skin. The survey will by default live in the folder that was open in the library at the time the “Create new survey” 124 button was clicked. Clicking “Create” 150 will create and save the survey name and id, close the modal window and change the parent window from the library to the edit survey page 106. In FIG. 9, the administrator 100 may enter a new name for a survey or folder. When “Rename” 152 is clicked the library page is refreshed with the new survey or folder name displayed.

In a preferred embodiment, as shown in FIG. 10, the administrator 100 is allowed to make a re-named copy of a survey or folder while leaving the original unchanged. It will be understood by one of ordinary skill in the art that a duplicate function window 154 works much like a “save as” function. The administrator 100 has the option of choosing a location for the duplicate other than the original folder. A duplicate function window 154 also offers the option of creating a new folder 156.

Referring now to FIG. 11, a move survey or folder window 158 is shown. The administrator 100 may move a survey or folder from one folder location to another. The move survey or folder window 158 also offers the option of creating a new folder 156.

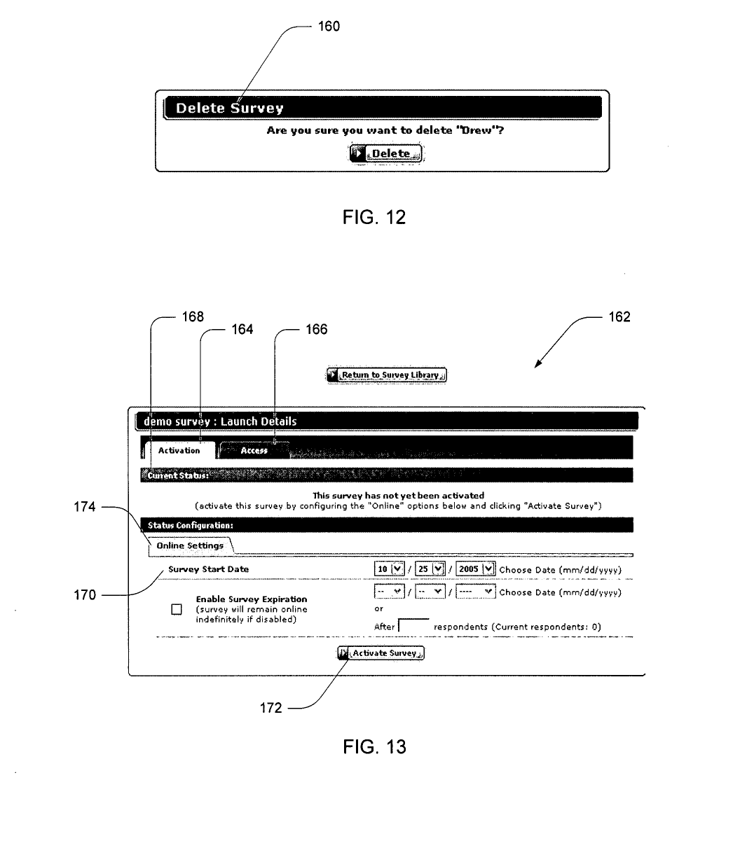

As shown in FIG. 12, a delete a survey or folder window 160 is shown. The administrator 100 may delete a survey or folder. If a survey is deleted then all respondent data related to that survey is deleted as well. If the survey contains a unique question not used in any other survey then that question will no longer be accessible. Any data associated with the question will also be deleted. The same is true for any surveys in a deleted folder.

Referring to FIG. 13, a launch detail window 162 is shown. Launch detail window 162 has two main tabs, “Activation” 164 and “Access” 166. In the “Activation” tab 164 shown in FIG. 13, the top of the page shows “Current Status” 168. The status could be one of: “online”, “offline”, “expired”, or “this survey has not yet been activated.” A survey is activated by configuring online settings 174. For example, the administrator 100 could configure the “Start date” 170, with the option of setting an expiration date and or a respondent limit and clicking an “Activate survey” 172 button. Respondent limits define the maximum number of respondents allowed to take a survey. For instance, if a survey has a respondent limit of five hundred, it will deactivate after five hundred respondents have completed the survey, even if this happens before the scheduled date of deactivation. Furthermore, administrators 100 may use the online settings 174 panel to schedule automatic activation and deactivation according to date. For example, an administrator 100 could schedule a survey to open, or activate on Apr. 1, 2005 and close, or deactivate, on May 1, 2005.

Additionally, a survey is considered in-active if it has not yet been set as online or offline. For example, it will be understood that In a database table such as sp_launch_details,” two fields called “date_online” and “date_offline” determine the actual status of the survey. If both of these fields are “null”, then the survey has not yet been activated. The survey is first cached in ”.htm” files on a network file system when the survey is turned online and any subsequent changes to the survey require it to be re-cached to display the changed to a live respondent.

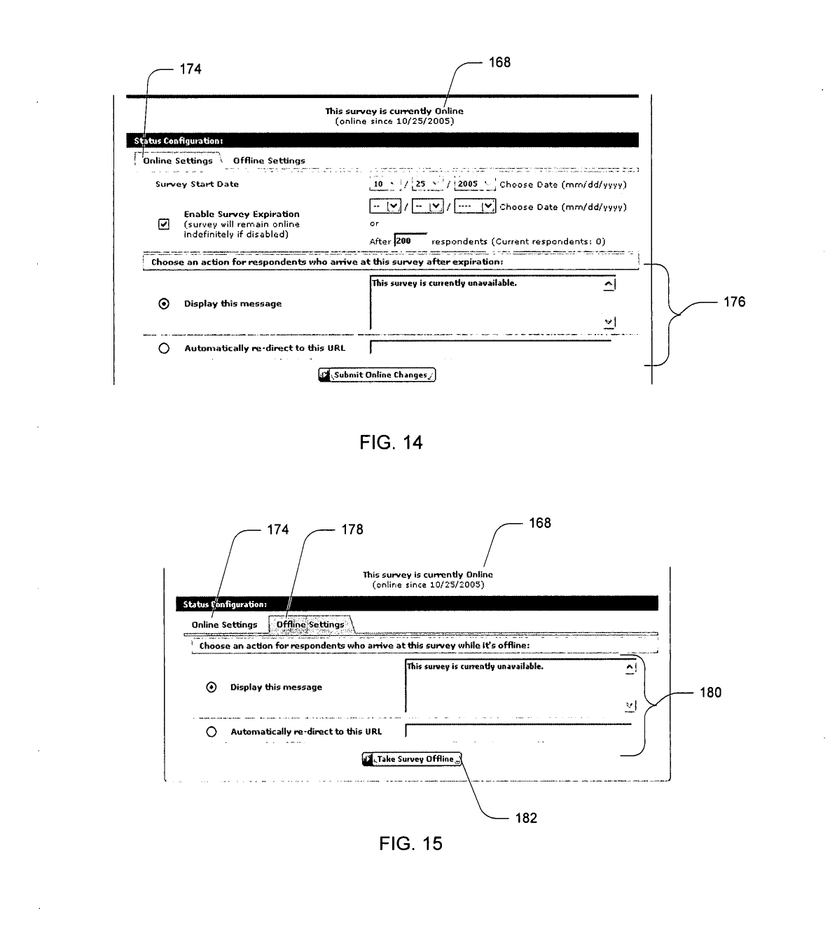

In another embodiment of survey polling system and method 101, online settings may be changed. FIG. 14 shows an additional panel when the online settings 174 are changed. The additional panel defines an option to create a custom message or redirect 176. Basically, if a survey has an expiration date or a respondent maximum limit set, then there is the option to create a custom message or a redirect (collectively 176) for users who access the page once it has expired. The administrator 100 may choose to display the custom message or redirect 176. For example, in FIG. 14 the phrase “This survey is currently unavailable” is shown in the custom message or redirect 176 panel. FIG. 14 also shows the “Current Status” 168 of the survey as “Online.”

As shown in FIG. 15, a survey may be taken offline by first clicking on an offline setting 178 tab. A custom message or redirect 180 can be created for surveys that have been taken offline manually. Thereafter, clicking a “Take Survey Offline” 182 button will change the status of the survey to “Offline.”

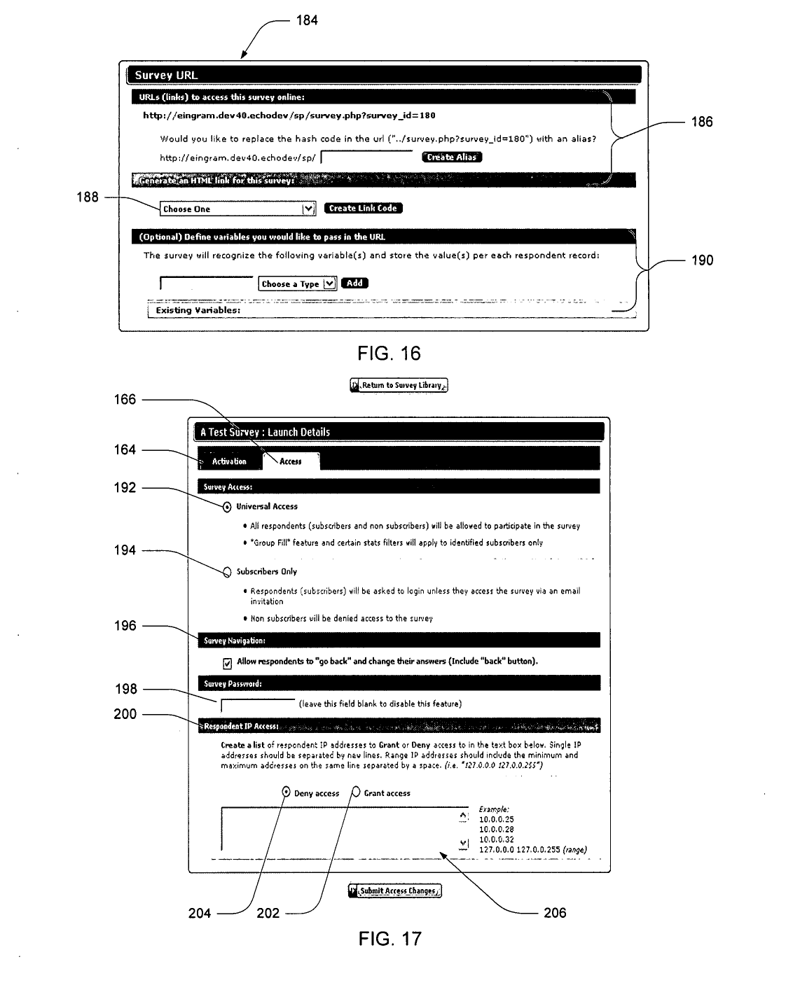

Furthermore, a “Survey URL” 184 panel shown in FIG. 16 appears once a survey is activated. It generates a live survey URL. The survey URL may include a long string of hash code tying it to the client data. Administrators 100 have the option of creating an alias 186 to replace the unattractive hash code section of the URL in order to simplify the URL. For example, the survey polling system may generate a link: http://echo.bluehornet.com/sp/client/custome1/q098we7987gwe97q2987398.htm The user or client has the option of creating an alias for the “q098we7987qwe97q2987398” section of the URL in order to create a more easily recognizable name. For example, the alias might be “survey1”, so the URL http://echo.bluehornet.com/sp/client/custome1/survey1.htm could be used as an alternative to the auto generated one.

Referring again to FIG. 16, the administrator 100 may generate an HTML link 188 for a survey. This helps the administrator 100 create a valid reference for their site or email invitation to the survey. Furthermore, this also generates a java script pop up code for the survey. In a preferred embodiment, the survey polling system allows the survey to be given a list of acceptable URL variables 190, or tokens, whose values will be collected as data per respondent. For example, the administrator may give http://echo......survey1.htm?refer=homepage as a URL variable 190. This would tell the survey to treat “refer” like a question and “homepage” as the answer for any respondent who reached the survey from that link. That way data generated outside the survey may be collected by the survey. In another embodiment, the administrator 100 may add a client id variable for respondents who were sent an invitation from a third party email tool.

Referring now to FIG. 17, the details of the “Access” 166 tab is shown. In the “Access” 166 tab when a “Universal Access” 192 button is selected, all respondents (subscribers and non subscribers) will be allowed to participate in the survey. Moreover, a “Group Fill” feature and certain statistical filters will apply to identified subscribers only. When “Subscribers Only” 194 button is selected, respondents (subscribers) will be asked to login unless they access the survey via an email invitation. Non-subscribers will be denied access to the survey. Also, a custom message can be added for non-subscribers. A “Survey Navigation” 196 option allows a respondent to go back and change answers. Furthermore, a “Password Creation” 198 option creates a password for survey access. The administrator 100 may leave the “Password Creation” 198 option field blank if they wish to disable the feature. In addition, a “Respondent IP Access” 200 option creates a list of respondent internet protocol (IP) addresses to “Grant” 202 or “Deny” 204 access to the survey in a text box 206 below. It will be understood by one of ordinary skill in the art that single IP addresses should be separated by new lines and range IP addresses should include the minimum and maximum addresses on the same line separated by a space (i.e. “127.0.0.0 127.0.0.255”).

In a preferred embodiment of survey polling system and method 101, a new survey may be created or an existing survey may be edited. The first step in creating a survey using the survey polling system and method 101 is to choose a type of survey. For instance, in survey polling system and method 101 a feedback survey may be chosen. A feedback survey is a survey which collects data from known or anonymous respondents. A feedback survey utilizes mail submitted upon entry or passed through a link in an invitation. No statistical data will be displayed to the respondent upon completion. Results will be displayed to the administrator 100 in a reporting 122 section (See FIG. 1) of survey polling system and method 101. Furthermore, known respondents may be segmented into groups based upon their answers. This segmentation into groups may be done either manually by the administrator 100 or automatically by a “fill group” definition determined by the administrator 100 at the time of survey creation.

Another example of a survey the administrator 100 may choose is a poll. A poll is a question or series of questions (radio buttons) that when responded to, show the respondent the overall results. The results are usually a percentage answer per respondent population. Furthermore, in a preferred embodiment, survey polling system has the ability to generate a quick poll which is a question or series of questions (radio buttons) that when responded to, show the respondent the overall results. The results are usually a percentage answer per respondent population. The survey polling system will generate code which can be inserted into user or client pages and stylized by the user or client. Once submitted the results will be displayed in a pop up window over the site. Results may be also be stylized on the client end. Another example of a survey is a test. In a preferred embodiment of survey polling system and method 101, a test is similar to the poll except all answers are assigned a right or wrong value and a respondent score can be stored and/or displayed.

In addition, an administrator 100 may choose algorithmic segmentation as the type of survey to be created. The goal of this type of survey is to segment all respondents into (x) buckets based upon their aggregate responses to all questions. This will be accomplished by assigning values for each of the (x) buckets to every possible answer and then setting up some “if” statements. It will be understood by one of ordinary skill in the art that an example of an “if” statement can be: “if the sum of values for all answers is highest for Bucket A, throw the respondent into Bucket A.”

Lastly, data collection in survey polling system and method 101 replaces standard survey data collection tools. Data collection is a type of survey that the administrator 100 may create to allow for multiple data collection pages, multiple digital object identifier messages, multiple opt out pages, and multiple welcome letters. There is also a higher degree of brand control in data collection surveys.

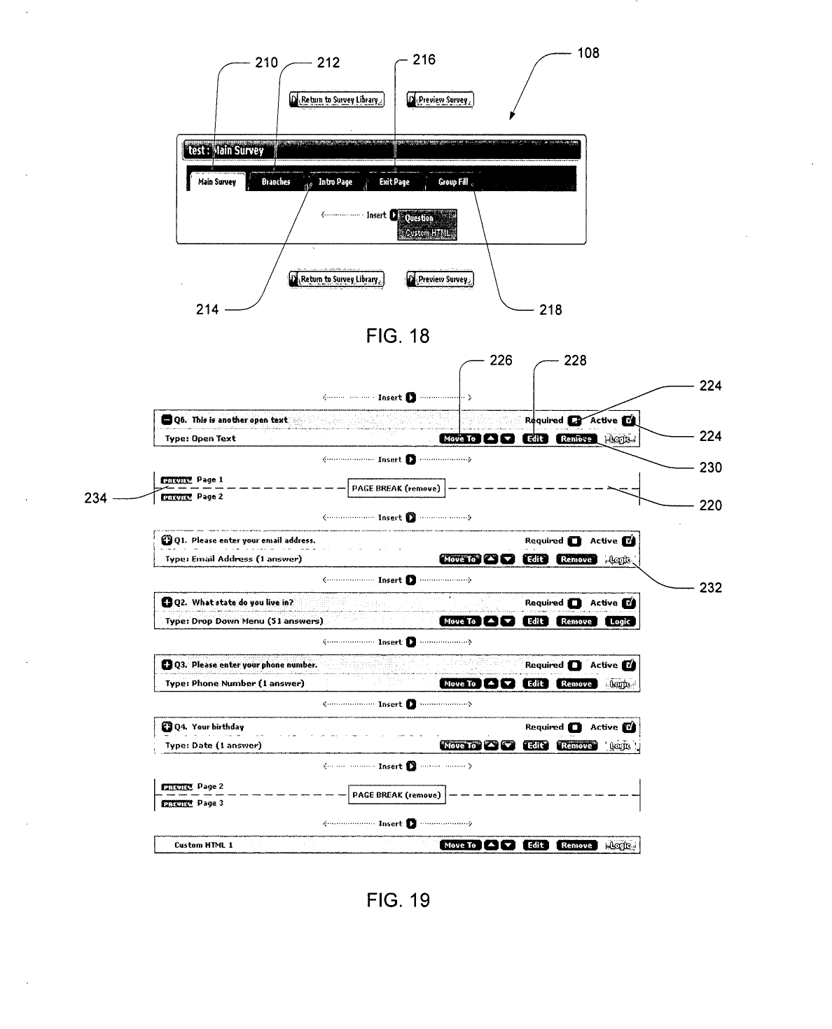

As shown in FIG. 18, there are five main tabs in an edit survey page 108. In a preferred embodiment of survey polling system and method 101, a “Main Survey” 210 tab is a page used to edit all major portions of the survey including questions, answers, logic, and validation. Additionally, a “Branches” 212 tab is the page where conditional logic would be set up in the survey to point to conditional branches of questions. Therefore management and navigation of all branches takes place for the administrator 100 under the “Branches” 212 tab. An “Intro Page” 214 tab is a custom introduction page to introduce respondents to the survey. This is very similar to a coversheet for the survey and is optional. An “Exit Page” 216 tab is the default final page for the survey, and “Group Fill” 218 tab is where the rules are set to auto populate groups based on response criteria.

Referring again to FIG. 18, the “Main Survey” 210 is the default landing tab for the edit survey page 108. This is the main interface for building survey pages, questions, answers, custom HTML inserts, and page breaks. FIG. 18 shows the page as it is first seen by the administrator 100.

Moreover, FIG. 19 shows the edit survey page 108 while building multiple page surveys. Page breaks are displayed by a dotted line 220. For each question there is an expanded view which shows the answers and any applied logic rules, with the exception of open text questions. There are buttons to make questions “required” or “non-required” 222, and “active” or “inactive” 224. Each question can be moved 226, edited 228, removed 230, or have logic rules 232 applied to it. Questions can be divided by page breaks and page breaks can be removed. The administrator 100 can also click to preview 234 each individual page.

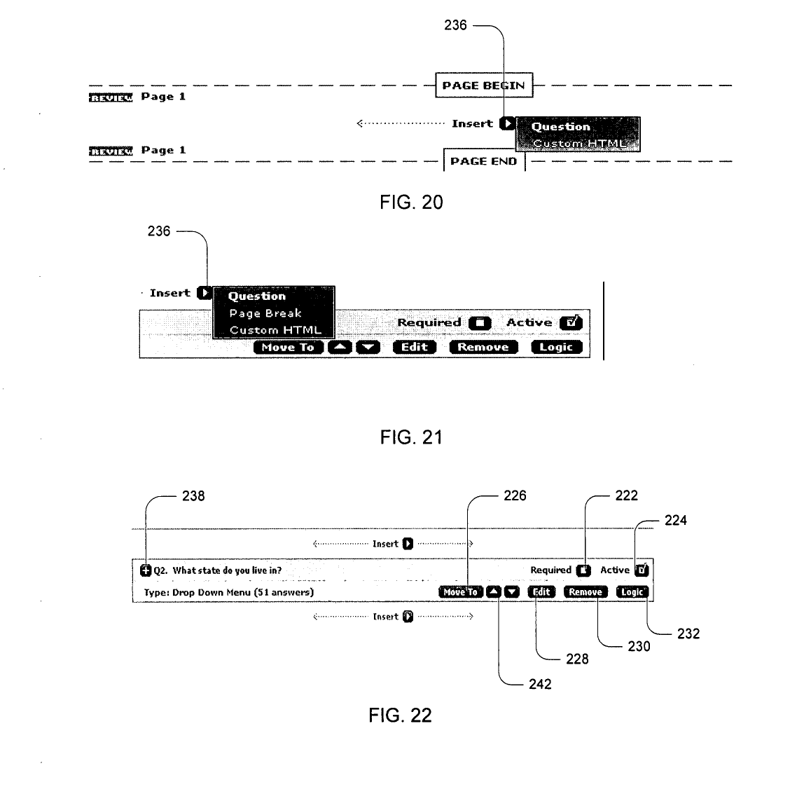

In addition, FIG. 20 shows a top insert 236 button which allows the administrator 100 to insert a question or some custom HTML. In a preferred embodiment of survey polling system, as shown in FIG. 21, all insert 236 buttons that are not the first or last on a page also offer the option of inserting a page break. This dynamically renumbers all pages automatically if added.

Referring to FIG. 22, several buttons on a question panel are shown. The plus sign 238 on the far left opens the panel to an expanded view which shows answer and logic details. A “Move to” 226 button opens a dialogue box to reposition a question. An up or down arrow 242 allows the administrator 100 to reposition the question one position at a time. An “Edit” 228 button opens a dialogue box to configure questions and edit survey text. A “Remove” 230 button removes, or deletes the question from the survey and deletes all historical data for that question associated with the survey. A “Logic” 232 button opens a dialogue window to configure conditional rules. Furthermore, a “Required” 222 button forces respondents to answer the question before moving on in the survey. Finally, an “Active” 224 button allows the administrator 100 to hide the question on the survey, but preserves the question data and all response data for the question associated with the survey.

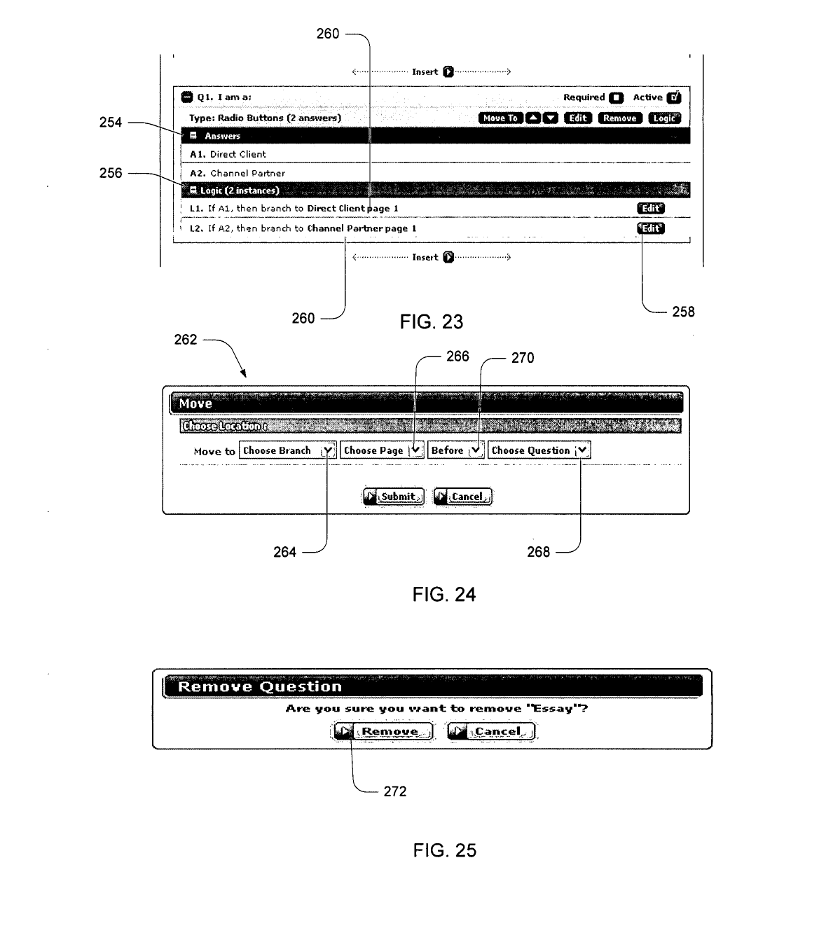

FIG. 23 shows the expanded view of the question panel in FIG. 22. FIG. 23 shows a complete list of all answers 254 and a list of all conditional logic rules 256 (if applicable) with a shortcut 258 to edit that particular rule. Also, branch names 260 act as a shortcut to open an edit page for that branch.

Clicking on the “Move to” 226 button in FIG. 22 takes the administrator 100 to a “Move” window 262. As shown in FIG. 24, the “Move” window 262 allows the administrator 100 to move a question 268 to a different branch 264, page 266, and specify location 270 on a page. Furthermore, clicking on the “Remove” 246 button from FIG. 22 will lead the administrator 100 to a “Remove” prompt 272. As shown in FIG. 25, a “Remove” prompt 272 confirms the intent to remove a question before removing

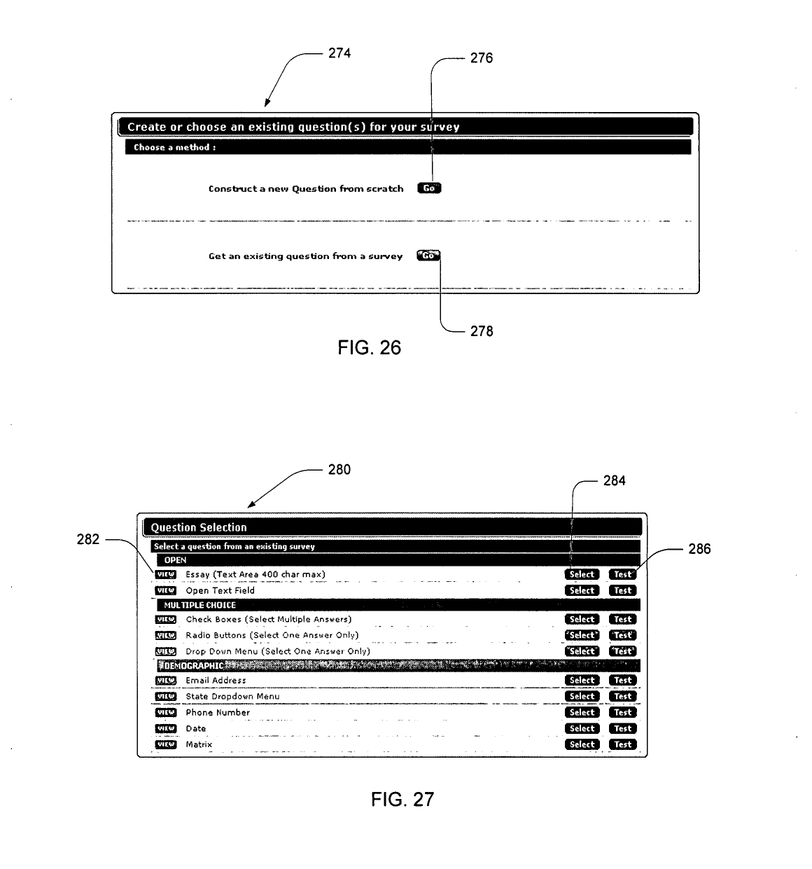

FIG. 26 shows a page administrator 100 would see if they clicked on the “Insert” 236 button from FIG. 21. As shown in FIG. 26, an “Create or Choose an Existing Question for Your Survey” 274 page, also referred to as the “Jump Page” allows the administrator 100 to choose between creating a question from scratch (new question) 276 or grabbing an existing question 278 from the current survey or any other survey in the system.

If the administrator 100 decides to select a question 278 from an existing survey (Shown in FIG. 26), then the page in FIG. 27 displays. FIG. 27 shows a “Question Selection” 280 template. The “Question Selection” 280 template lists the types of question templates available and has a “View” 282 button that opens a tool tip window when the administrator 100 “hovers” a mouse over the button to show a visual example. Moreover, the template has a “Select” 284 button to choose the type and has a “Test” 286 button. As shown in FIG. 27, the administrator 100 may base questions on text fields, multiple choice, and customer demographics. It will be understood by one of ordinary skill in the art that customer demographics may include email addresses, phone numbers, and dates they joined the database.

It will be understood by one of ordinary skill in the art that within the functional details, all additions and changes made inside the editing windows are saved to a temporary undo table in the database. No changes made inside the windows will take affect or be added unless a “Submit” button is clicked at the bottom of the page. Once clicked, the original question (if editing) is deleted and a new question is created with the data constructed within this window. If the window is close in any other way, all previous additions and changes are lost.

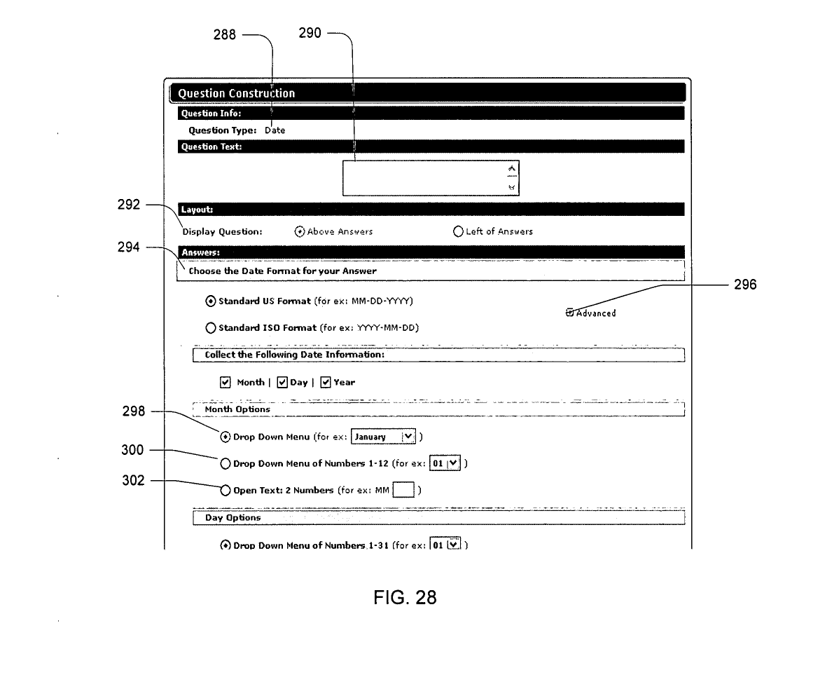

In a preferred embodiment of survey polling system and method 101, questions may be inserted. Accordingly, FIG. 28 shows how the administrator 100 would insert a new question. A question type for “Date” 288, for example, would require certain steps. The administrator 100 would type “Question Text” 290 and then “Choose question display” 292 alignment with answers. Furthermore, the administrator 100 would “Choose a date format” 294 (standard or international standards organization). An “Advanced” 296 button opens a view to specify the data to be collected, such as day, month, and year. The administrator 100 may then determine answer form types for all answers, such as “Drop Down Menu” 298 for words, “Drop Down Menu” 300 with numbers, or “Open Text” 302. These aspects can be applied to both month and display options.

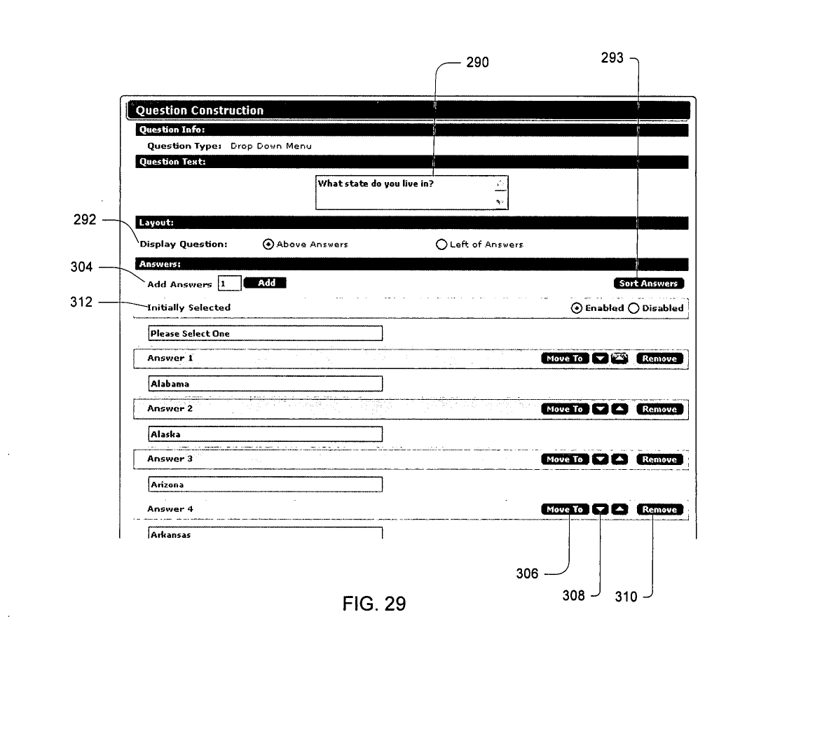

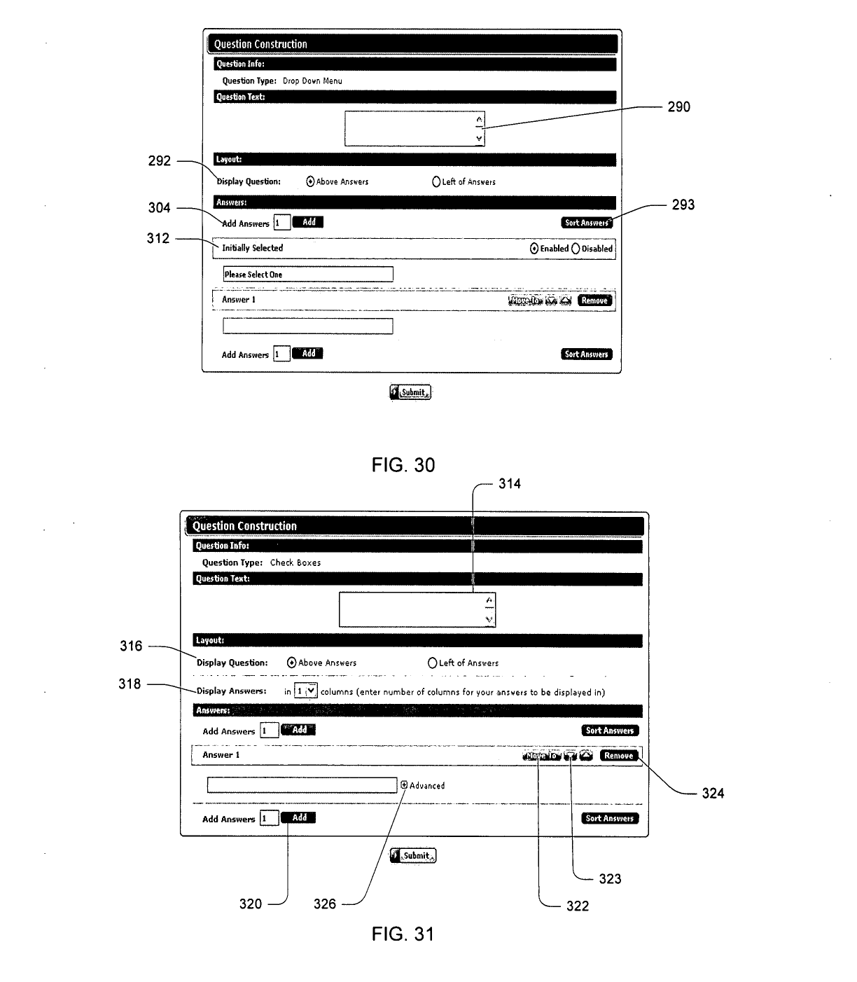

As shown in FIGS. 29 and 30, a page to insert a new question regarding drop down states from FIG. 28 is shown. The administrator 100 would type “Question Text” 290 then “Choose question display” 292 alignment with answers. A “Sort Answers” 293 button can be clicked to change the order of the answers as well. Thereafter, the administrator 100 would click an “Add answers” 304 box to add open text fields and to add more answer values. A “Move To” 306 button opens a dialogue box where the administrator 100 can jump the answer to any position in the answer list. Up and down arrows 308 allow the administrator 100 to move the answer position up or down one position at a time. The “Remove” 310 button removes an answer value. “Initially selected” 312 is the initial form value displayed by default. This can be enabled or disabled.

As shown in FIG. 31, to insert a new question regarding check boxes an administrator 100 would perform certain steps. First, they would type “Question text” 314. Next, the administrator 100 would choose question display alignment 316 with answers. Finally the administrator 100 would choose how many columns 318 to display answers. For example, nine answers displayed in three columns would result in three columns of three answers. Or nine answers displayed in two columns would result in one column of five answers and one column of four answers. Furthermore, an “Add Answers” button 320 will add open text fields to add more answer values. A “Move To” 322 button opens the move to dialogue box where the administrator 100 can jump the answer to any position in the answer list. Up and down arrows 323 allow the administrator 100 to move answer position up or down one position at a time. A “Remove” 324 button removes an answer value and an advanced option 326 allows the administrator 100 to specify a check box initial state which is unchecked by default.

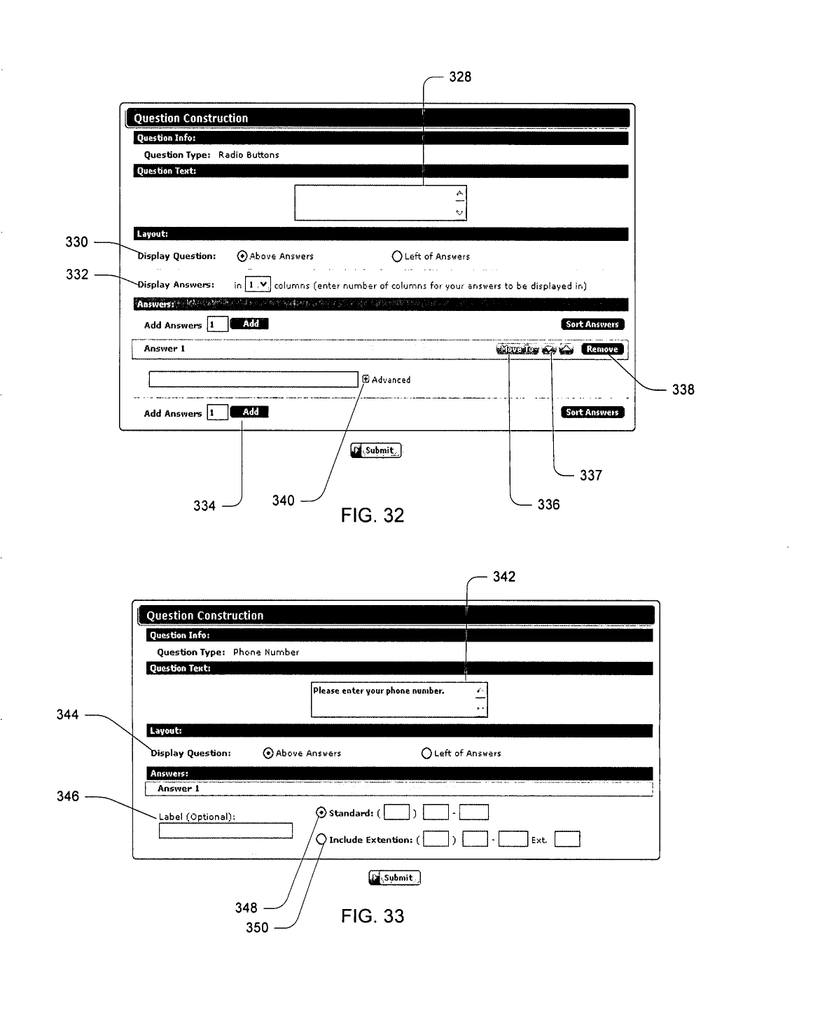

In another embodiment, as shown in FIG. 32, to insert a new question regarding radio buttons an administrator 100 would perform certain steps. First, they would type “Question text” 328. Next, the administrator 100 would choose question display alignment 330 with answers. Finally the administrator 100 would choose how many columns 332 to display answers. For example, nine answers displayed in three columns would result in three columns of three answers. Or nine answers displayed in two columns would result in one column of five answers and one column of four answers. Furthermore, an “Add Answers” button 334 will add open text fields to add more answer values. A “Move To” 336 button opens the move to dialogue box where the administrator 100 can jump the answer to any position in the answer list. Up and down arrows 337 allow the administrator 100 to move answer position up or down one position at a time. A “Remove” 338 button removes an answer value and an advanced option 340 allows the administrator 100 to specify radio buttons initial state which is unchecked by default.

FIG. 33 shows a screen to insert a new question regarding phone numbers. The administrator 100 would first type “Question text” 342 and then choose question display 344. An optional “Label” 346 dialog box allows the administrator 100 to place a label next to the answer form, such as “home” or “work” label. When entering a phone number, a standard number 348 may include an extension 350 or non-standard numbers such as foreign numbers.

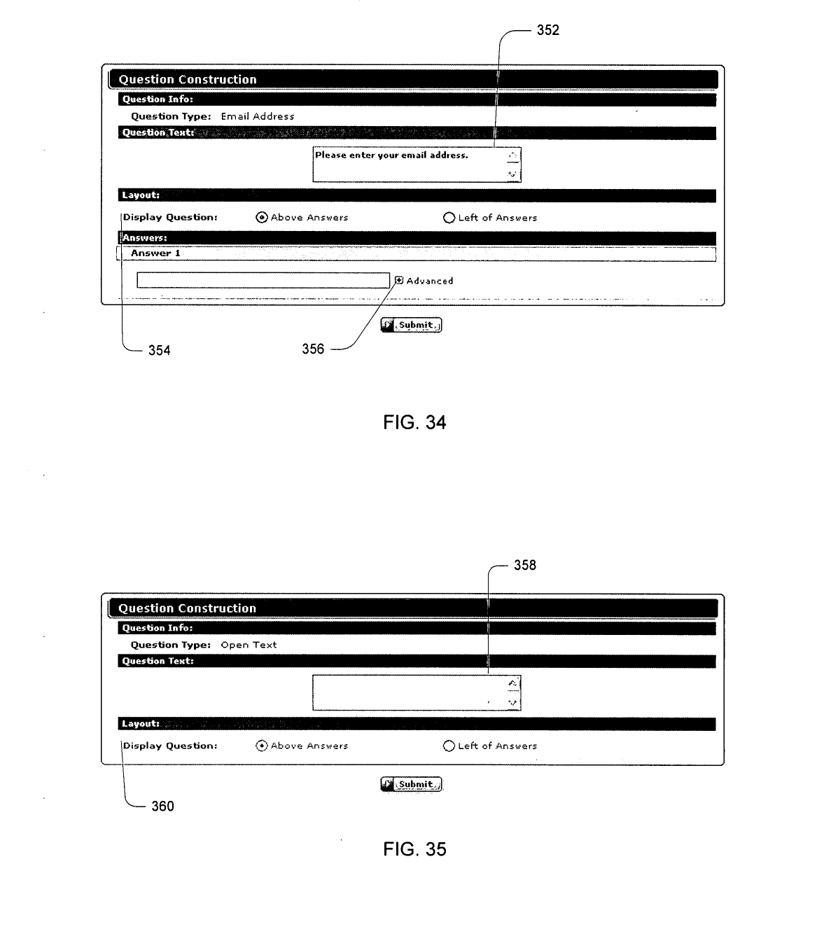

As shown in FIG. 34, to insert a new question regarding email address, the administrator 100 would first type “Question text” 352 and then choose question display 354. Open text answer fields will act as initial value for the answer on a client facing survey. A client facing page will validate the input as an email value. An “Advanced” 356 button allows the administrator 100 to require an email address be re-typed, or two entries, on the survey. The page will also validate that these entries are identical.

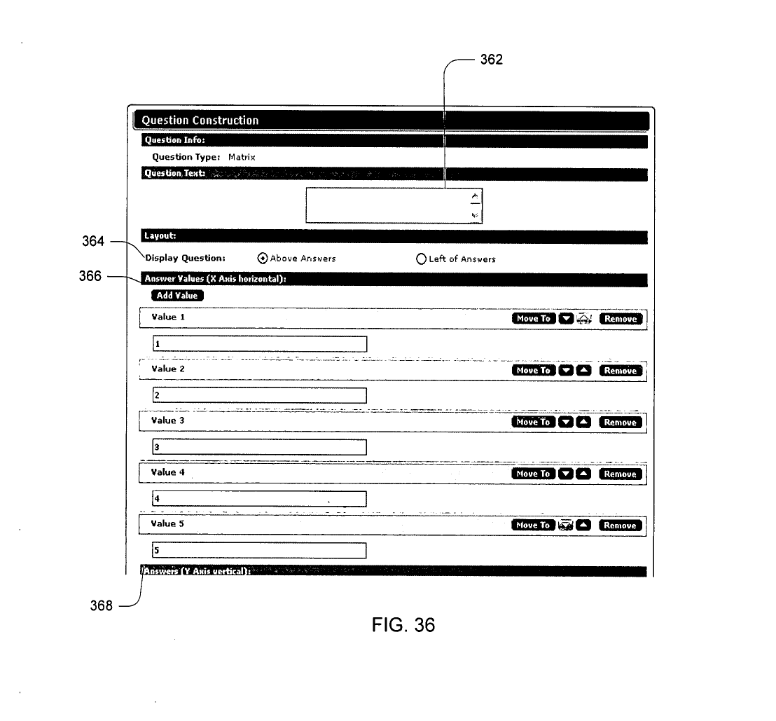

As shown in FIG. 35, to insert a new question regarding open text, the administrator 100 would first type “Question text” 358 and then choose question display 360. Moreover, the administrator 100 may choose columns and rows for text or maximum characters. FIG. 36 shows a screen to insert a new question regarding matrix. The administrator 100 would first type “Question text” 362 and then choose question display 364. Next, the administrator 100 would define “Answer Values for X Axis” 366. For example, the administrator 100 could define the “Answer Values for X Axis” 366 as “Never, Seldom, Often, Always.” Next, the administrator 100 would define “Answer Values for Y Axis” 368. For example, the administrator 100 could define the value as “Do you use conditioner?”

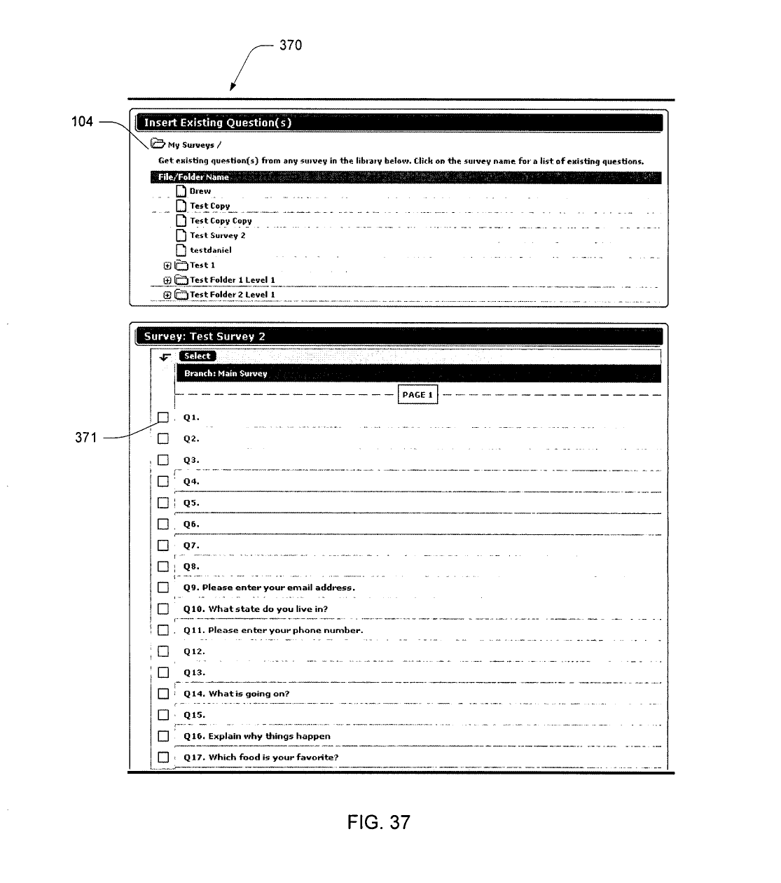

FIG. 37 describes a screen for inserting an existing question. If the administrator 100 chooses to insert an existing question into the survey an “Insert Existing Question” 370 dialogue box opens. At the top of the page is the survey library 104 which allows the administrator 100 to navigate and open a survey. It will be understood by one of ordinary skill in the art that the current survey is open by default. Once a survey is open below the library 104, displaying all branches and pages breaks, the administrator 100 can check as many questions 371 as they desire to move into a current survey. These questions 371 also have properties associated with them that are carried over from the existing question in another survey except for the following properties of “active status”, “required status”, and “conditional logic”. These particular properties are unique to the question in relation to the specific survey. Once the administrator 100 clicks “Select”, the page closes and the Edit Survey page 108 refreshes with all new questions placed in the location the insert button was initially clicked.

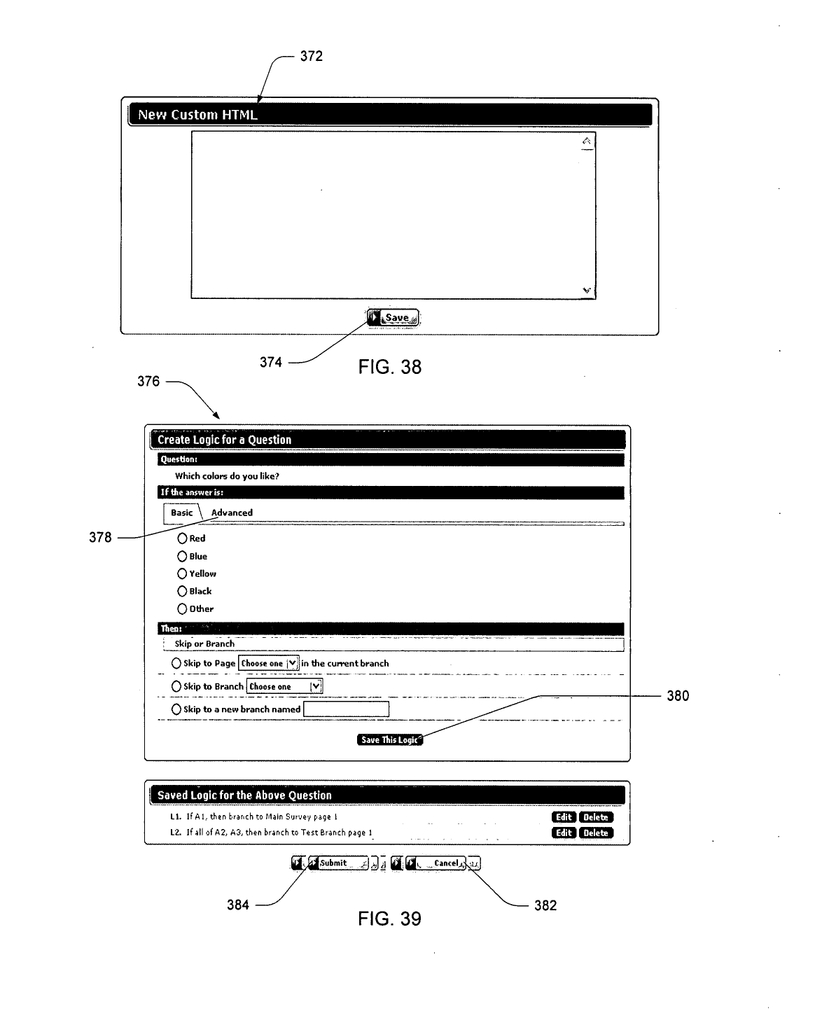

Turning now to FIG. 38, the administrator 100 may choose to insert custom HTML into the survey. An “Insert Custom HTML” 372 dialogue box opens. This is a text box for inputting HTML code and it allows the administrator 100 to place any desired HTML above or below a question. They may choose to add imagery, flash, or any HTML. For example, if a question had to do with gathering opinions about a new pilot TV advertisement, the administrator 100 could place a QuickTime movie above the question for viewing in the survey. It will be understood by one of ordinary skill in the art that once “Save” 374 is hit the HTML will be inserted in the survey at the location the insert button was initially clicked.

FIG. 39 illustrates a screen for adding conditional logic to questions. The administrator 100 may choose to add a condition branch or skip logic to a question into the survey. A “Create Logic for a Question” 376 dialogue box opens as shown in FIG. 39. This allows the administrator 100 to set a conditional “if, then” rule for any and all responses to a question.

It will be understood that there are generally two types of “if” statements, basic and advanced. Basic allows the administrator 100 to specify logic for a unique response. For example, the administrator 100 could specify logic as “if the answer is blue, then skip to branch five.” Furthermore, advanced allows the administrator 100 to specify logic for an array of answers. In FIG. 39, an “Advanced” 378 tab allows the administrator 100 to specify logic for “Any of” or “All of” the specified answers. For radio buttons or drop downs the “Advanced” 378 tab allows the administrator 100 to specify logic for “Any of” the specified answers. For example, for radio buttons or drop downs, the administrator 100 may specify logic as “If the answer is ‘Blue, or Red, or Green’ then skip to branch five. Moreover, for check boxes the administrator 100 may chose to specify logic as “If the answer is ‘Blue, Red, and Green’ then skip to branch five.”

It will also be understood that the “Then” part of the rule allows the administrator 100 to choose to have a respondent who meets the requirements to skip to a page in the current branch or skip to a different branch. Furthermore, there may be multiple rules, or instances of logic, applied to each question. For example, the administrator 100 could have a rule one that says “If the answer is ‘Blue’ then skip to branch five. Rule two could be “If the answer is ‘Red’ then skip to branch six” and rule three could be “If the answer is ‘Green’ then skip to branch seven.” These instances could be listed at the bottom of the page. After a rule is created the administrator 100 clicks the “Save this logic” 380 button and the rule is added to the list. The administrator 100 can edit specific rules, delete them, or save all the logic for the question and return to the Edit Survey page 108. Moreover, the administrator 100 may create several rules with the window open and if they decide they do not wish to save these they may click “Cancel” 382 and none of the rules (stored in temporary tables) will be applied. If they click “Submit” 384 the rules will be moved from the temporary table to a permanent table and saved and applied.

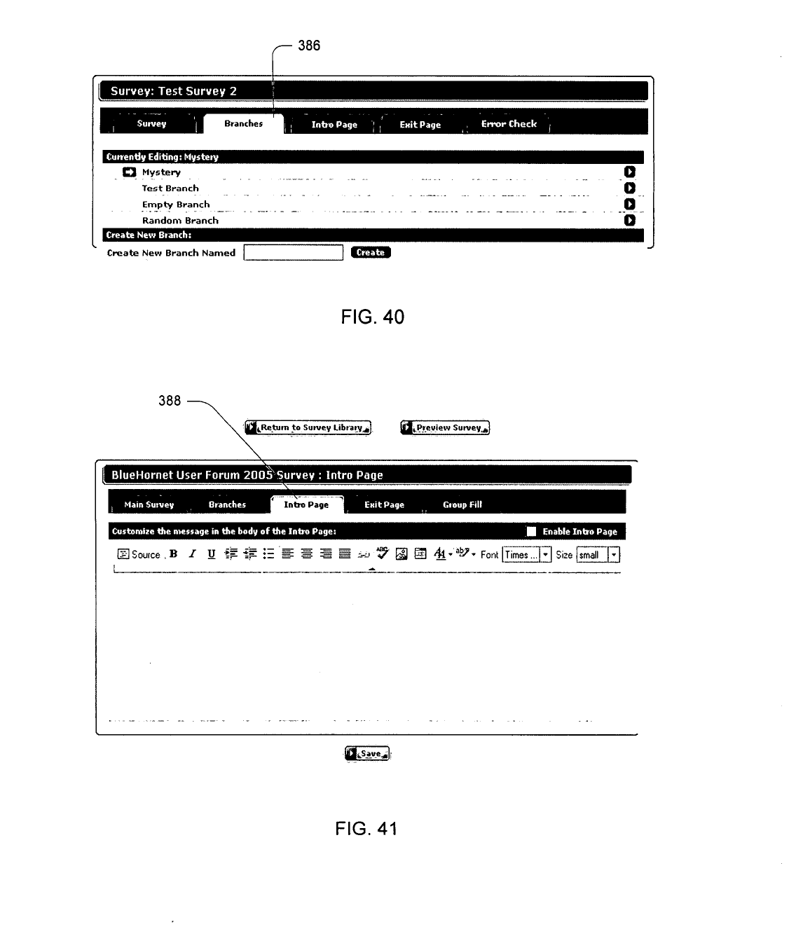

As shown in FIG. 40, a “Branches” 386 tab lists all secondary branches of questions that the administrator 100 may create in order to dynamically corral respondents through a series of questions that are relevant based on prior answers. Branches are given a title when created. An arrow of a particular color, such as green, indicates the survey branch that is currently open for editing. The administrator 100 may click on the name of any branch in order to open and edit the branch. It will be understood that all edit survey features are similar. One added feature is the ability to specify a unique action when the branch is finished. Actions include sending respondents to the main survey exit page, sending respondents to a specific page in the main survey, and sending respondents to a unique exit page. The benefit of the third action is that administrator 100 can send respondents to unique pages (through a redirect or a link) based on the path they went through for the survey. For example, a respondent may be sent to a coupon page based on certain path of response.

An “Intro Page” 388 tab is shown in FIG. 41. This allows the administrator 100 to create a welcome or introductory page for their survey. It will be understood by one of ordinary skill in the art that this is optional and may be disabled. As shown in FIG. 41, the administrator 100 may edit the welcome or introductory page with various font types and page set up features.

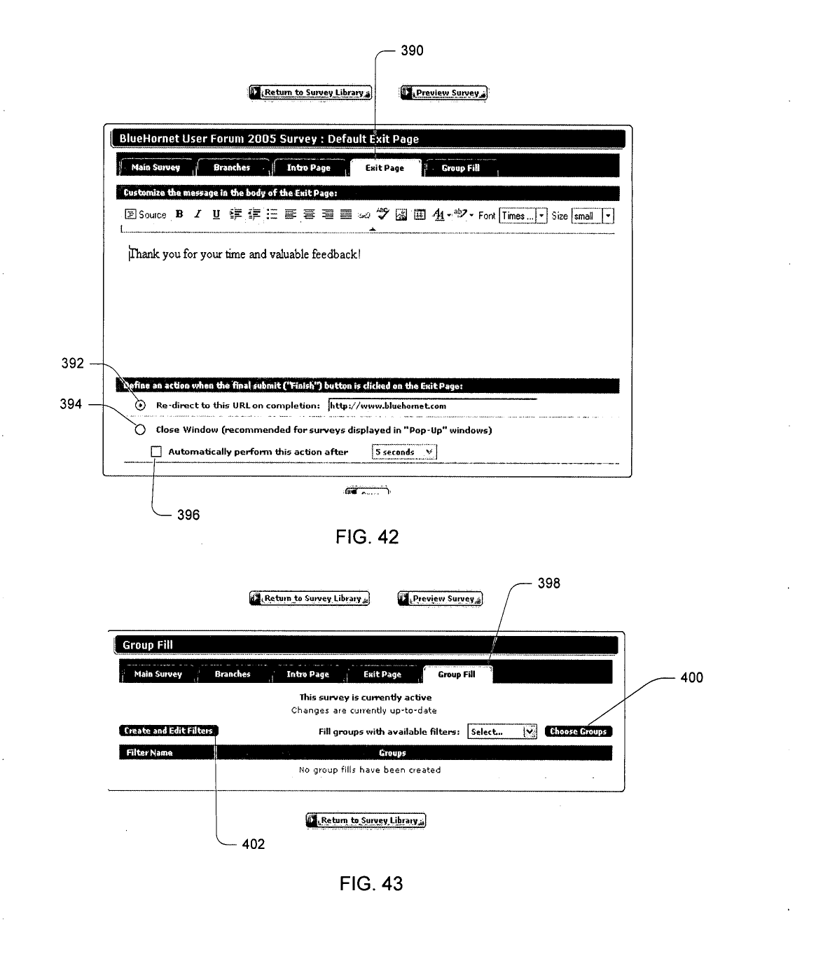

FIG. 42 shows an “Exit Page” 390 tab. In a preferred embodiment of survey polling system and method 101, this function allows the administrator 100 to create a default page that all respondents pass through after completing the survey. The administrator 100 may specify a redirect URL 392 function which is triggered by clicking a finish button. Furthermore, the administrator 100 may specify a close window 394 function. The close window 394 function may be set to a specific time frame 396.

Next, FIG. 43 describes a “Group Fill” 398 tab. This function allows the administrator 100 to populate groups of identified subscribers based on responses to a question or combinations of questions across one or multiple surveys. This is accomplished on this page by pairing a filter, based on response criteria, and a group or set of groups 400. A filter may be chosen from a list of previously created filters at the top of the page, or one may be created by clicking a “Create and edit filters” 402 button.

It will be understood that group fills are not unique objects. Instead, they are a number of groups from a client's EMS selected into one list and applied to a filter. Only one filter may have a set of groups applied to it at once. Once groups are added to a filter, the filter is removed from a dropdown list at the top of the page which should only display unused filters. If a set of groups are removed, the filter is again made available in the dropdown at the top of the page.

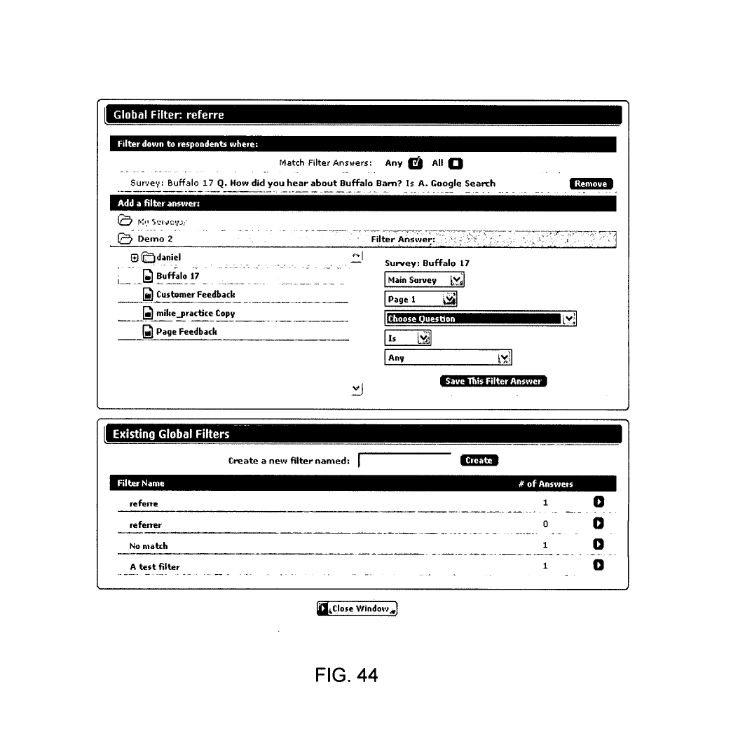

Referring now to FIG. 44, filters are created by choosing a response or a group of responses from one or more surveys. To setup a filter, first a survey is chosen, then a branch, then which question is to be looked at, then whether the answer “is or is not” to be a particular answer. If more than one response is part of the criteria then there is an “All or Any” option to apply to the group of responses. Filters work globally and once they are created can be applied to both, Group Fill, and Statistics, on any survey.

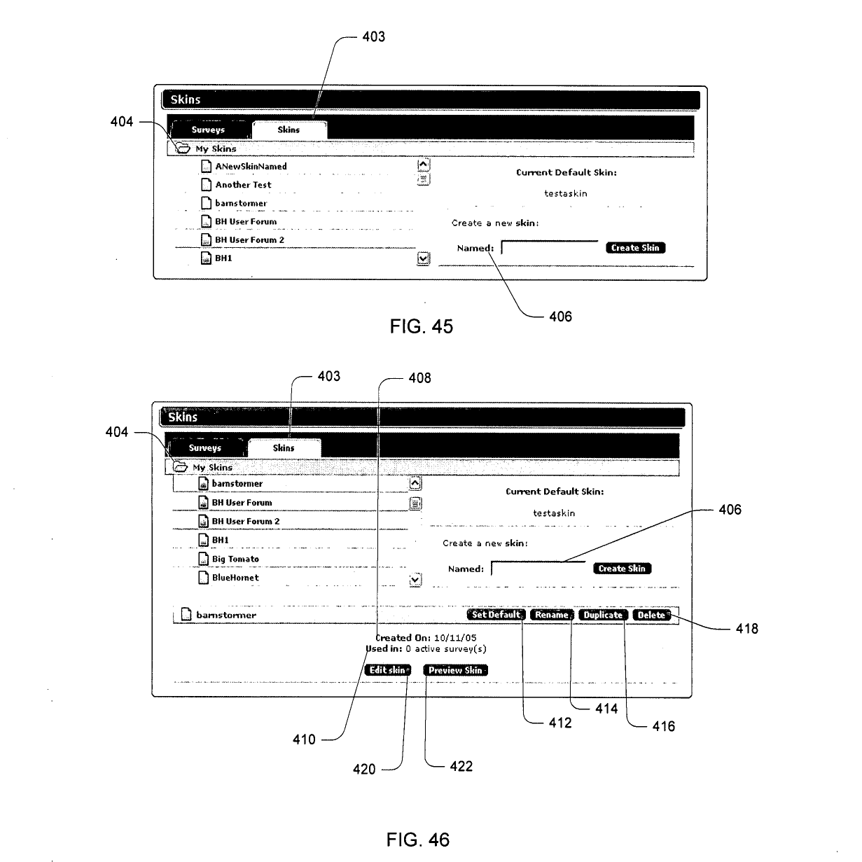

As shown in FIG. 45, a library for survey skins or templates is similar to the Survey Library 104. However, a survey skin library 403 does not support folders. One skin may be set as the default skin for the system surveys. This means if a skin is not specified the default will be applied.

Again referring to FIG. 45, there are two types of skins that can be created, custom or standard. Custom allows the administrator 100 to upload a full page of HTML with a replacement tag in the body that will determine the location of the survey content. The standard method will allow the administrator 100 to create all page elements with the tools in the editors. In FIG. 45, the administrator 100 may choose a previously created skin under “My Skins” 404. Or, they may create a new skin and choose a name 406.

FIG. 46 shows the skin library 403 of FIG. 45 expanded. After clicking on a skin the library expands to display information and actions available for that skin. Information displayed includes date created 408 and which surveys are using the skin currently 410. An option is provided to set a skin as the system default survey skin 412. Rename 414, duplicate 416, and delete 418 are also options to edit skins.

On first view the administrator 100 will be given an instance of a global default skin. They can modify this skin to their liking, make a copy of this skin and modify that or create a new skin from scratch. If they create a new skin, they have the option of making that the default skin for all new surveys. A default skin cannot be deleted until another skin is chosen as the default. If for any reason the administrator 100 is able to delete all their skins, a new instance of the global default will automatically be copied into their library. Furthermore, an “Edit Skin” 420 and “Preview Skin” 422 button are available if the administrator 100 wishes to edit or preview the skin.

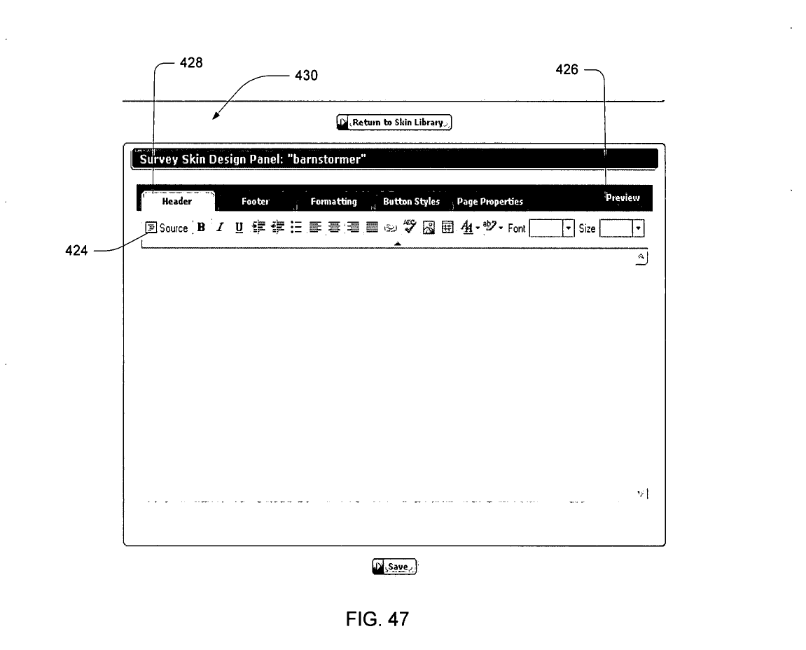

FIG. 47 shows a standard skin creation panel 430. The administrator 100 may create a custom survey header 428 using a WYSWYG HTML editor or may paste in code for the header using a “Source” 424 view on the editor. A “Preview” 426 button will open a window to preview the design during creation.

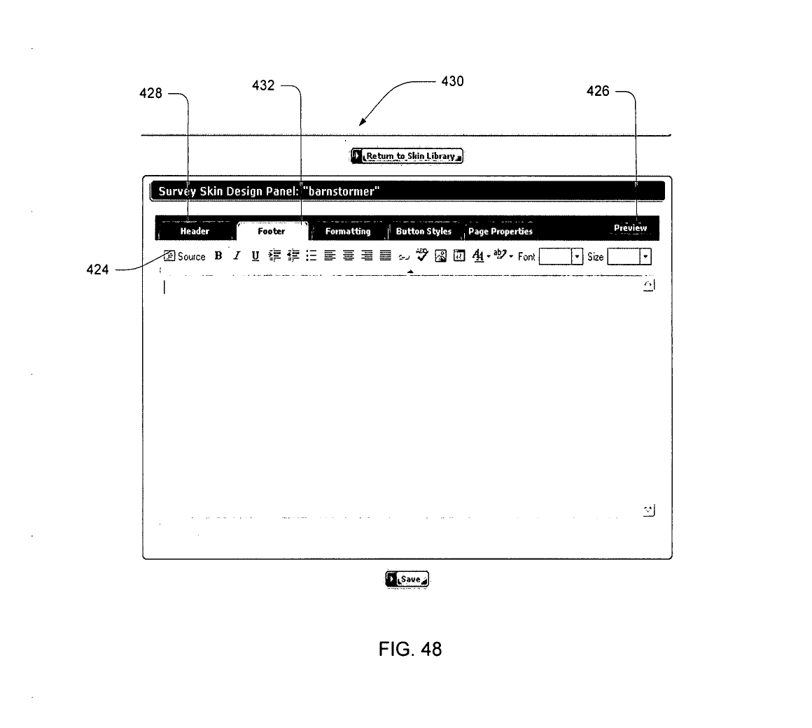

Conversely, as shown in FIG. 48, the administrator 100 may create a custom survey footer 432 using the WYSWYG HTML editor or may paste in code for the footer using the “Source” 424 view on the editor. A “Preview” 426 button will open a window to preview the design during creation.

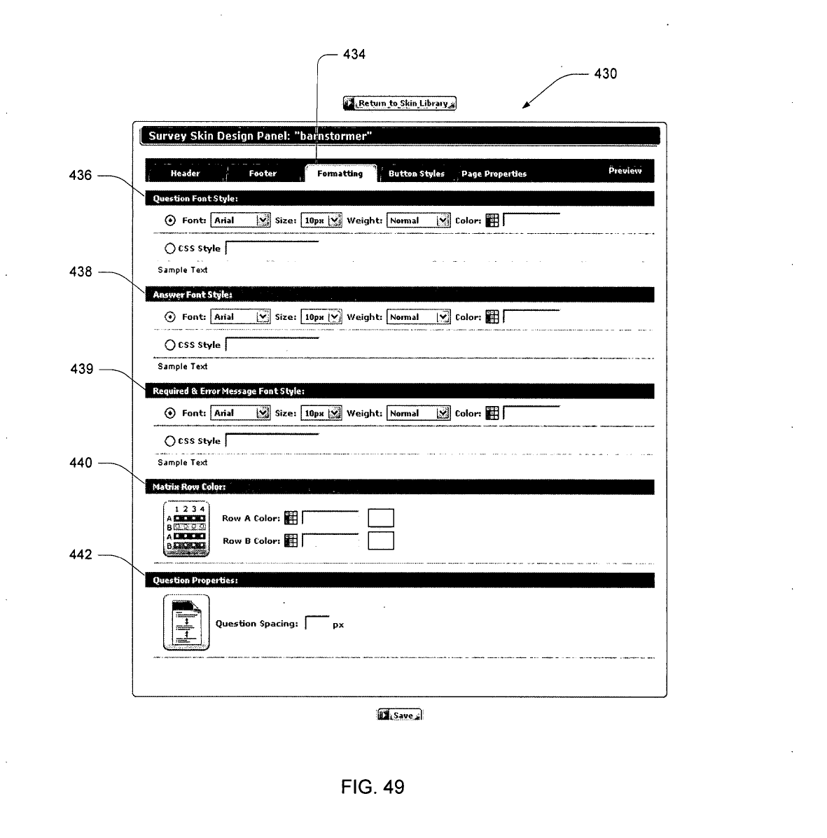

FIG. 49 shows a formatting 434 tab in the standard skin creation panel 430. This allows for the formatting of question font styles 436, answer font styles 438, required and error message styling 439, matrix question type styling 440, and spacing between each question in the survey in pixels 442. For standard skin design, if the administrator 100 wants to use specific cascading style sheets (CSS) for the fonts they should specify them in the header HTML section in order for them to display.

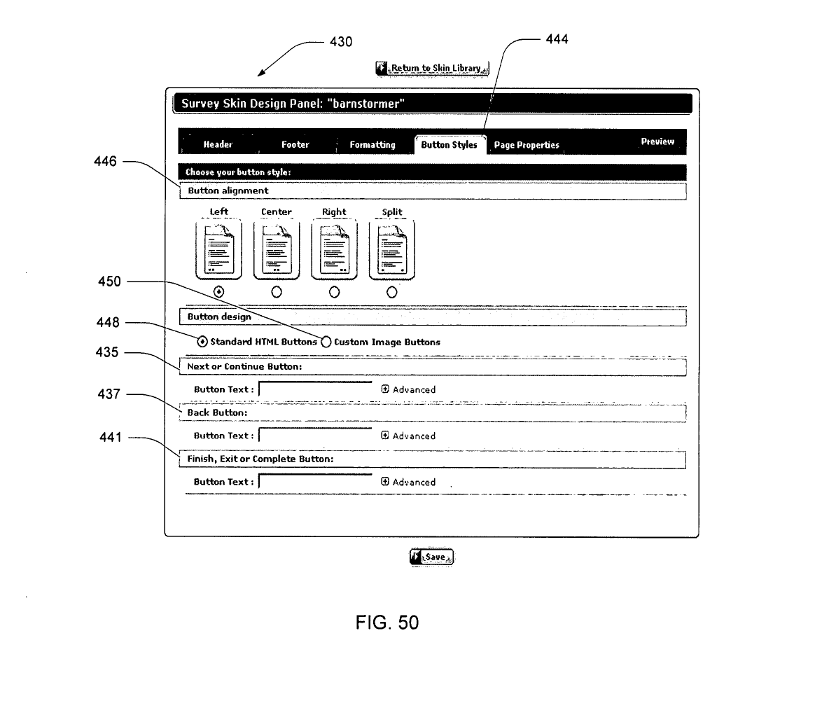

Referring now to FIG. 50, a “Button Styles” 444 tab is shown on the standard skin creation panel 430. This allows for the formatting of alignment of buttons 446 on the page and choosing between standard HTML buttons 448 or custom image based buttons 450. If custom image button 450 is checked, a new set of controls allows for static and rollover states of the button as well as alt tag text. The administrator 100 may also edit a “Next or Continue Button” 435, a “Back Button” 437, and a “Finish, Exit, or Complete Button” 441. Button text may be entered for each of these and advanced settings may also be applied.

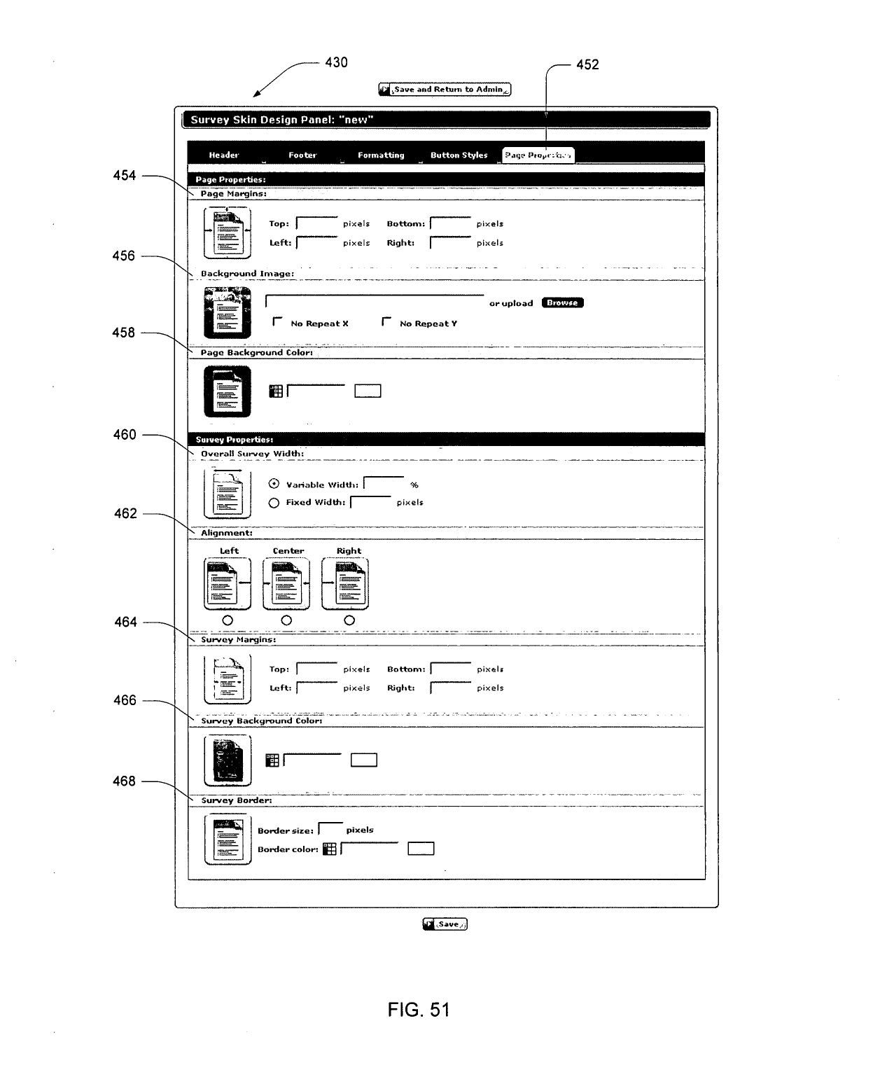

FIG. 51 shows the standard skin creation panel 430 with “Page Properties” 452. The “Page Properties” 452 tab allows for setting “Page Margins” 454, “Background Image” 456, “Page Background Color” 458, “Overall Survey Width” 460, survey “Alignment” 462 on page, “Survey Margins” 464, “Survey Background Color” 466, and “Survey Border” 468. The “Background Image” 456 defines an option of tilting vertical or horizontal. Moreover, the “Overall Survey Width” 460 may be fixed or variable. The “Survey Border” 468 may be changed by color and size requirements. It will be understood that the “Survey Margins” 464 may be edited to a particular pixel requirement and may change the top, bottom, left and right margins.

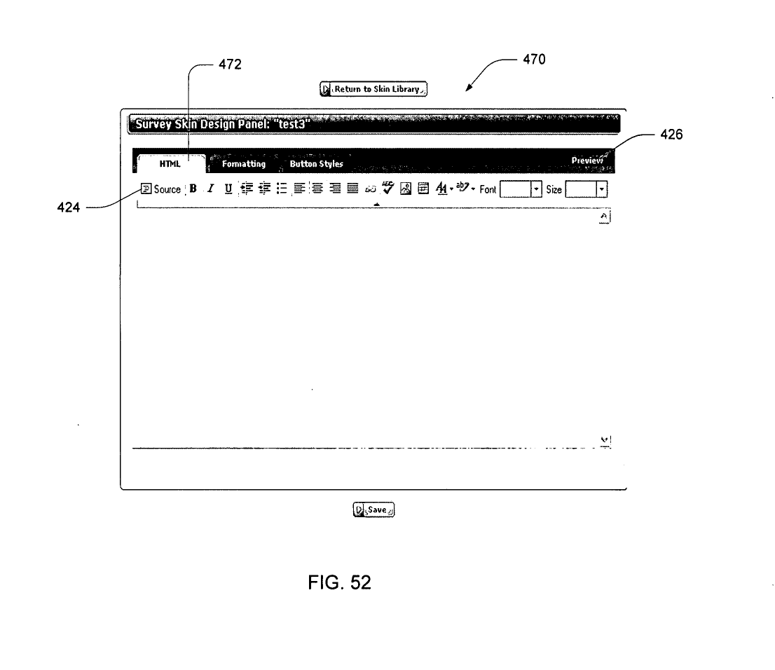

FIG. 52 shows a custom skin creation panel 470. This page allows the administrator 100 to upload HTML that will wrap the survey. An “HTML” 472 tab is shown in FIG. 52. The page should contain a tag “%%surveyhere%%” where the survey is to reside. Furthermore, all images and links on the page should be absolute. FIG. 52 is similar to FIG. 47 because there is also the preview 426 button and source 424 function.

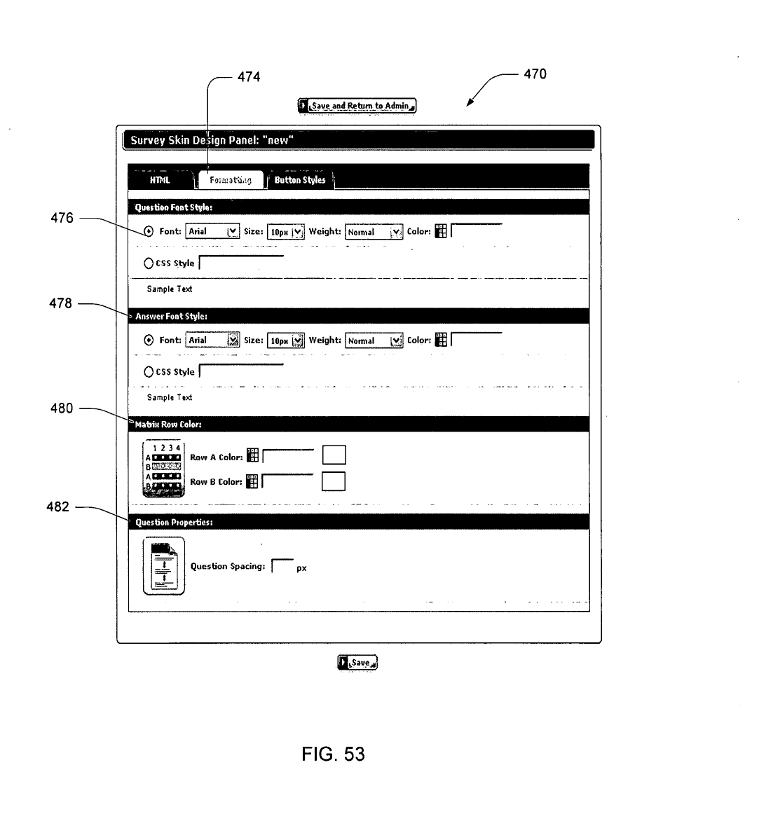

Referring now to FIG. 53, the custom skin creation panel 470 is shown with a “Formatting” 474 tab. This allows for formatting of “Question Font Styles” 476, “Answer Font Styles” 478, “Matrix Row Color” 480, and “Question Properties” 482. “Question Properties” 482 handles spacing between each question in the survey in pixels.

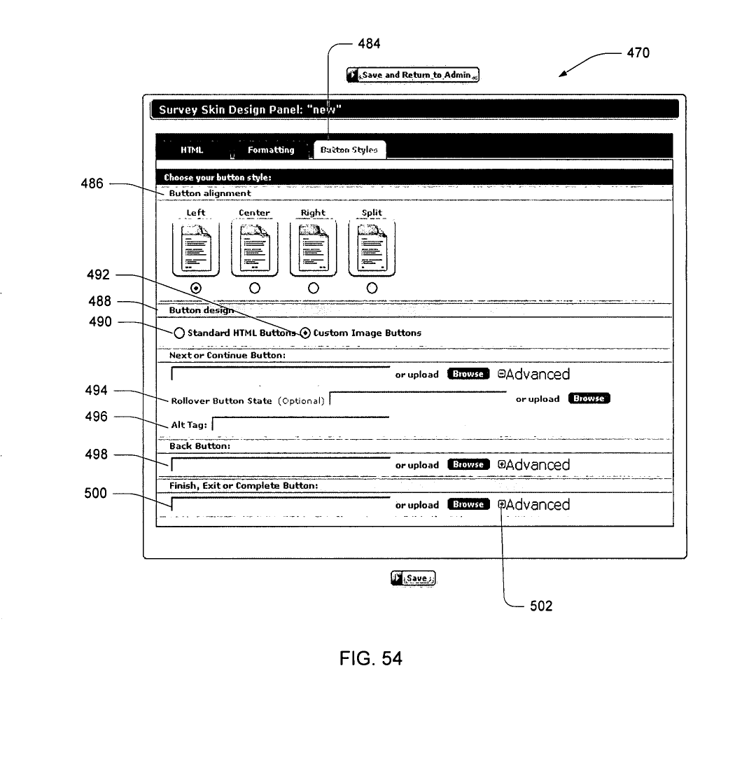

FIG. 54 shows a custom skin creation panel 470 with a “Button Styles” 484 tab. The “Buttons Styles” 484 tab allows for formatting of “Button Alignment” 486 and “Button Design” 488. The administrator 100 can choose a “Button Design” 488 between standard HTML 490 buttons or custom image based 492 buttons. If image button 492 is checked the page offers a new set of controls to allow for static and rollover states 494 of the button as well as alt tag 496 text. Furthermore, the administrator 100 may create a “Back Button” 498 and a “Finish, Exit, or Complete Button” 500. An “Advanced” 502 button provides further editing of the “Back Button” 498 and the “Finish, Exit or Complete Button” 500.

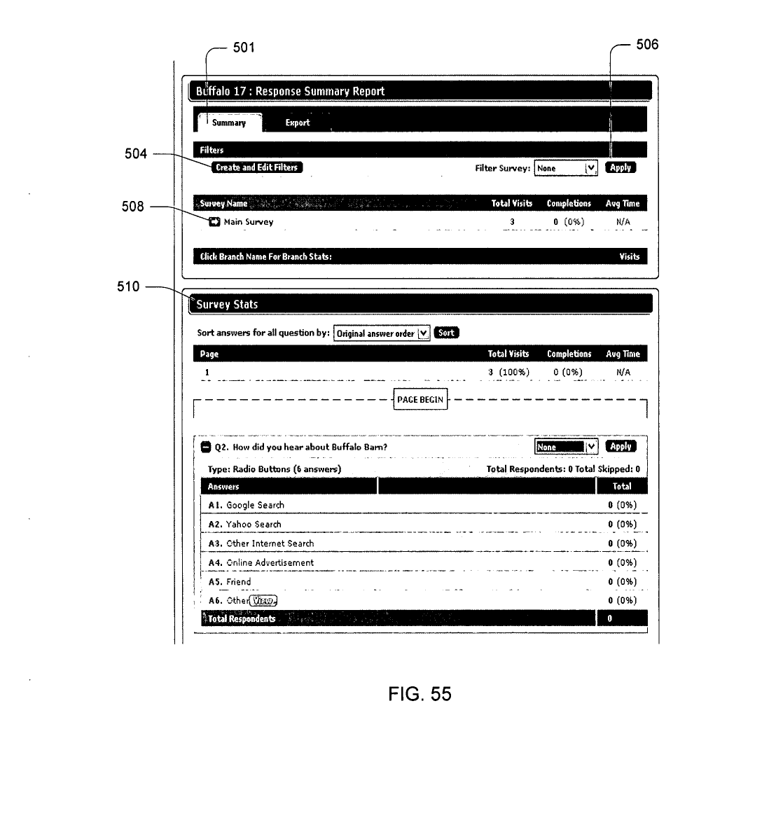

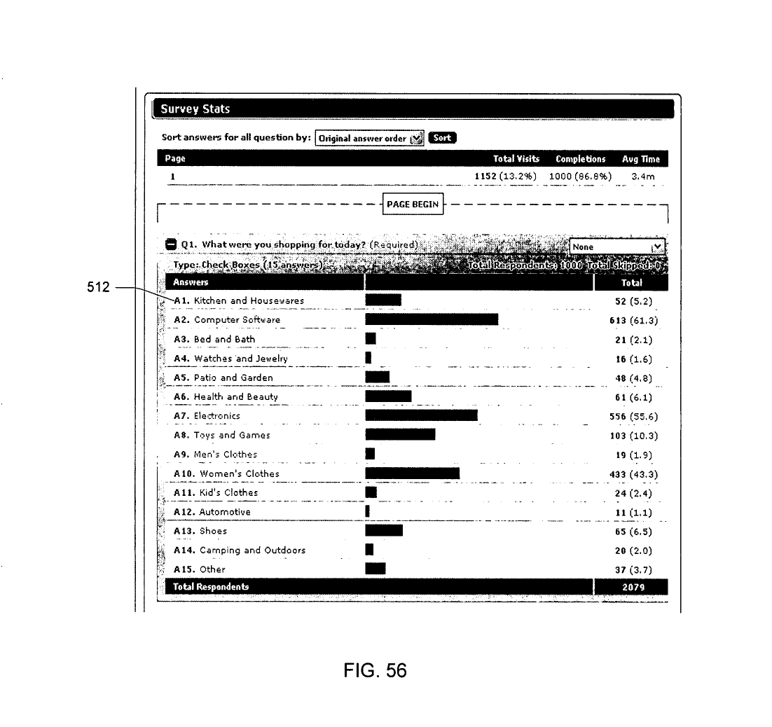

FIG. 55 shows a summary response data display page for a statistical data set created from a survey. A “Summary” 501 tab is displayed in FIG. 55. It will be understood that the statistical data was generated from a survey with particular filters shown in FIG. 44. Again in FIG. 55, the administrator 100 may “Create and Edit Filters” 504. Furthermore, they may apply a “Filter Survey” 506. A “Survey Name” 508 section shows a list of surveys and the number of total visits, completions, and average time to complete. Additionally, a “Survey Stats” 510 section sorts answers for all questions by an order chosen by the administrator 100. FIG. 56 shows the page of FIG. 55, but with a survey question type of checkboxes shown. FIG. 56 displays a range of answers to the particular question type. For example, answer “A1. Kitchen and Housewares” 512 came to a total respondent level of 52 out of 2079 total respondents.

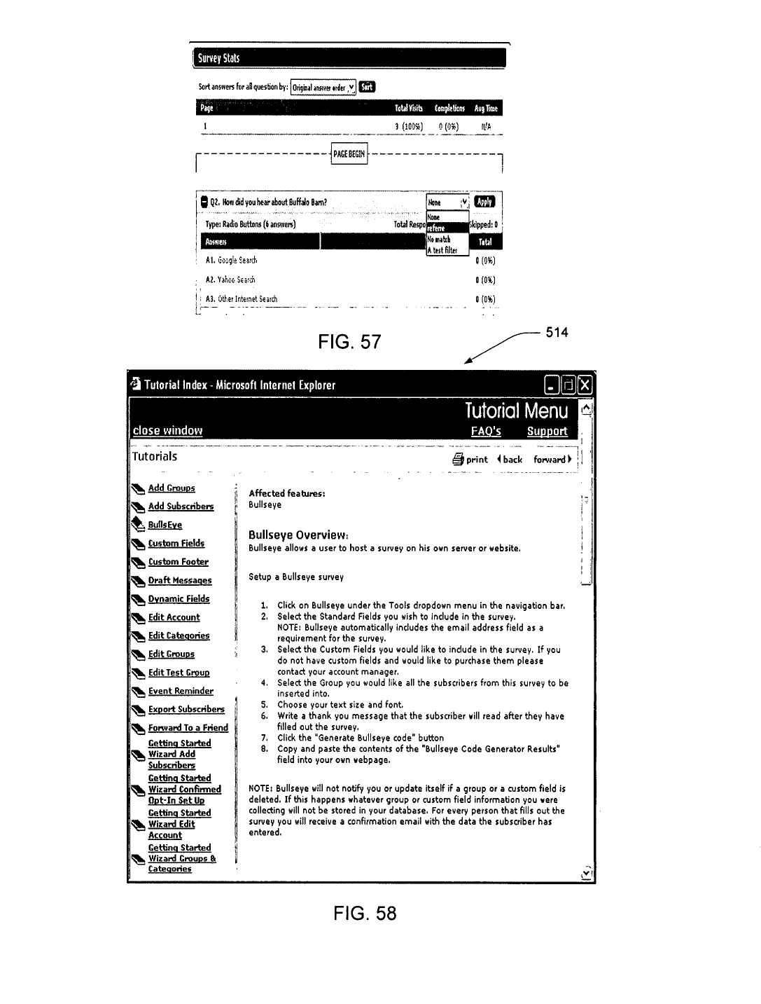

Furthermore, FIG. 57 shows that filters can be applied to entire survey statistical report or to individual questions. Once a filter is applied response data displays matches only those subscribers who met the criteria of the filter. For example if the first question in the survey asked for gender, then a filter could be created for “Males” and could be applied to the entire survey stats report, in order to get a unique view of how males responded.

It will be understood that survey polling system and method 101 may export a comma separated value (CSV) file that is detailed at a per-respondent level. This includes all responses and any variable values passed into the survey via the access URL of each respondent. In addition, a define document type definition (DTD) file function has full user interface (UI) and backend support for importing survey definitions (for Edit Survey and design) as XML files.

FIG. 58 shows a “Tutorial Index” 514. This describes in laymen's terms the functionality of a feature from a user's perspective and step-by-step instructions on its use. For features that are extremely complex or have too many options to cover, a single step-by-step instruction on the most common use case is described.

Furthermore, survey polling system and method 101 is designed and built with support for international characters in mind. All web displays (pages and panels) are encoded in a single, standard unicode encoding. A database schema also supports multi-byte strings in the encoding selected. Additionally, all hypertext preprocessor (PHP) string handling code must use the multi-byte-enabled functions to insure no string data is coerced into 8-bit American Standard Code for Information Interchange (ASCII). All strings stored in the database are encoded in the unicode encoding.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

1. A computerized survey polling system for use on a network, comprising:
a database having customer profile data where each customer record includes an email address and at least one of: a customer demographic, a preference setting, and a shopping behavior;
a software module operatively configured to build a survey from the customer profile data using multi-part rules; and
an email campaign manager operatively configured to send the survey to a customer over the network from a subscriber list derived from the customer profile data.

2. The survey polling system of claim 1 wherein the software module is operatively configured to store a survey in a library.

3. The survey polling system of claim 1 wherein the software module is operatively configured to edit a survey in a library.

4. The survey polling system of claim 3 wherein the software module is operatively configured to perform an edit action selected from a group consisting of:
move, rename, duplicate, and delete a survey.

5. The survey polling system of claim 1 wherein the software module is operatively configured to create a rule for survey duration such that a user can enable a survey start date.

6. The survey polling system of claim 1 wherein the software module is operatively configured to activate a survey such that the survey can receive customer input over a network.

7. The survey polling system of claim 1 wherein the software module is operatively configured to gather survey response results and enable queries of the results such that survey campaign statistics can be gathered whereby a user can review the survey campaign statistics.

8. The survey polling system of claim 1 wherein the software module is operatively configured to manipulate a survey responder record based on the responder being assigned points for answering questions and then determining a category for the survey responder record based on a total number of assigned points.

9. The survey polling system of claim 1 wherein the software module is operatively configured to send a survey result to another subscriber list.

10. A method for managing surveys for use on a network, comprising steps of:
storing customer profile data where each customer record includes an email address and at least one of: a customer demographic, a preference setting, and a shopping behavior;
building a survey from the customer profile data using multi-part rules; and
sending the survey to a customer over the network from a subscriber list derived from the customer profile data.

11. The method of claim 10 wherein the building step further comprises storing a survey in a library.

12. The method of claim 10 wherein the building step further comprises editing a survey in a library.

13. The method of claim 12 wherein the building step further comprises performing an edit action in the library selected from a group consisting of: move, rename, duplicate, and delete surveys.

14. The method of claim 10 wherein the building step further comprises creating a rule for survey duration such that a user can enable a survey start date.

15. The method of claim 10 wherein the building step further comprises activating a survey such that the survey will be configured to receive customer input over a network.

16. The method of claim 10 wherein the building step further comprises gathering survey response results and enabling queries of the results such that survey campaign statistics can be created whereby a user can review the survey campaign statistics.

17. The method of claim 10 wherein the building step further comprises manipulating a survey responder record based on the responder being assigned points for answering questions and then determining a category for the survey responder record based on a total number of assigned points.

18. The method of claim 10 wherein the building step further comprises sending a survey result to another subscriber list.

19. The method of claim 10 wherein the building step further comprises designing a skin.
